(19) United States
(12) Patent Application Publication
(10) Pub. No.: US 2025/0004625 A1
(43) Pub. Date: Jan. 2, 2025

(54) ELECTRONIC DEVICE COMPRISING FLEXIBLE DISPLAY, AND OPERATING METHOD FOR ELECTRONIC DEVICE

(71) Applicant: Samsung Electronics Co., Ltd., Suwon-si (KR)

(72) Inventors: Younsun LEE, Suwon-si (KR); Juyoung KIM, Suwon-si (KR); Changhwan KIM, Suwon-si (KR); Hyunjung MOON, Suwon-si (KR); Sungchan BAE, Suwon-si (KR)

(21) Appl. No.: 18/886,336

(22) Filed: Sep. 16, 2024

Related U.S. Application Data
(63) Continuation of application No. PCT/KR2023/003043, filed on Mar. 6, 2023.

(30) Foreign Application Priority Data
Apr. 19, 2022 (KR) 10-2022-0048346
Jul. 21, 2022 (KR) 10-2022-0090503

(51) Int. Cl. G06F 3/04845; G06F 3/0481; G06F 3/14

(52) U.S. Cl. CPC G06F 3/04845; G06F 3/0481; G06F 3/14

(57) ABSTRACT

A method for operating an electronic device is provided. The method includes changing a size of a first display area in response to identifying a user input instructing the electronic device to perform a sliding operation, and based on a size of a first user interface (UI) object included in the first display area, displaying the first UI object in a first display area and a second UI object corresponding to the first UI object in a second display area while the size of the first display area is changed, wherein the first display area includes a size-variable area, and the second display area includes a size-fixed area.

### CROSS-REFERENCE TO RELATED APPLICATION(S)

This application is a continuation application, claiming priority under § 365(c), of an International application No. PCT/KR2023/003043, filed on Mar. 6, 2023, which is based on and claims the benefit of a Korean patent application number 10-2022-0048346, filed on Apr. 19, 2022, in the Korean Intellectual Property Office, and of a Korean patent application number 10-2022-0090503, filed on Jul. 21, 2022, in the Korean Intellectual Property Office, the disclosure of each of which is incorporated by reference herein in its entirety.

### BACKGROUND

### 1. Field

The disclosure relates to an electronic device including a flexible display and a method for operating the same.

### 2. Description of Related Art

Portable electronic devices, such as smartphones and tablet personal computers (PCs), are becoming lighter and thinner for ease of portability, and are seeking to develop in various fields for ease of use. Use of an electronic device with a larger screen may give more convenience in, e.g., web browsing or multimedia playing through such a portable electronic device. To output a larger screen, the electronic device may come equipped with a larger display. However, ease of portability of the electronic device needs to be taken into consideration.

Accordingly, flexible electronic devices are being developed according to market demands. Flexible electronic devices may include curved electronic devices that are fixed with a specific curvature, foldable electronic devices that may bend beyond a specific radius of curvature or bend about a folding axis, and rollable electronic devices that may be rolled to a specific radius of curvature.

A rollable electronic device with a rollable display may provide a relatively larger screen than a typical bar-type electronic device and, as the display screen is rolled in the housing, its size may reduce, contributing to portability. Rollable electronic devices also have the advantage of being able to be used in various states depending on the degree of extension of the rollable display.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and electronic device which is capable of rearrangement of user interface (UI) objects displayed on a display including a variable area of an electronic device.

Another aspect of the disclosure is to provide an operation method and electronic device for maintaining or recovering UI objects rearranged based on whether there is a user input while driving for screen extension is performed.

Additional aspects will be set forth in part in the description which follows and, in part, will be apparent from the description, or may be learned by practice of the presented embodiments.

In accordance with an aspect of the disclosure, a method for operating an electronic device is provided. The method includes changing a size of a first display area in response to identifying a user input instructing the electronic device to perform a sliding operation, and, based on a size of a first UI object included in the first display area, displaying the first UI object in the first display area and a second UI object corresponding to the first UI object in a second display area while the size of the first display area is changed, wherein the first display area includes a size-variable area, and the second display area includes a size-fixed area.

In accordance with another aspect of the disclosure, an electronic device is provided. The electronic device includes memory storing one or more computer programs, a rollable display including a second display area having a fixed size and a first display area drawn out from or drawn into the electronic device, and one or more processors, wherein the one or more computer programs include computer-executable instructions that, when executed by the one or more processors individually or collectively, cause the electronic device to, in response to identifying a user input instructing the electronic device to perform a slide operation, change a size of the first display area, and display a first UI object in the second display area and the first display area while the size of the first display area is changed, based on a size of the first UI object included in the first display area, wherein a size of the second display area is not changed.

An electronic device and a method for operating the same, according to an embodiment of the disclosure, provides the effect of efficiently identifying a user input through a user interface while an electronic device including a rollable display performs an operation for extending the screen.

In accordance with another aspect of the disclosure, one or more non-transitory computer-readable storage media storing computer-executable instructions that, when executed by a processor individually or collectively, cause an electronic device to perform operations are provided. The operations include changing a size of a first display area in response to identifying a user input instructing the electronic device to perform a sliding operation, and based on a size of a first user interface (UI) object included in the first display area, displaying the first UI object in a first display area and a second UI object corresponding to the first UI object in a second display area while the size of the first display area is changed, wherein the first display area includes a size-variable area, and the second display area includes a size-fixed area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an electronic device according to an embodiment of the disclosure;

FIG. 3A illustrates a first state of an electronic device according to an embodiment of the disclosure;

FIG. 3B illustrates a second state of an electronic device according to an embodiment of the disclosure;

FIG. 4A is a cross-sectional view illustrating an electronic device according to an embodiment of the disclosure;

FIG. 4B is an exploded perspective view illustrating an electronic device according to an embodiment of the disclosure;

FIG. 5 illustrates a change in a user interface according to an embodiment of the disclosure;

FIG. 6 illustrates an operation flow of an electronic device according to an embodiment of the disclosure;

FIG. 7 illustrates a display of a user interface according to a sliding operation of an electronic device according to an embodiment of the disclosure;

FIG. 8A illustrates a movement of a first user interface (UI) object in a user interface according to FIG. 7 according to an embodiment of the disclosure;

FIG. 8B illustrates a movement of a second UI object in a user interface according to FIG. 7 according to an embodiment of the disclosure;

FIG. 9 illustrates a display of a user interface according to a sliding operation of an electronic device according to an embodiment of the disclosure;

FIG. 10 illustrates a change in a first UI object in a user interface according to FIG. 9 according to an embodiment of the disclosure;

FIG. 11 illustrates a display of a user interface according to a sliding operation of an electronic device according to an embodiment of the disclosure;

FIG. 12 illustrates a display of a user interface according to a sliding operation of an electronic device according to an embodiment of the disclosure;

FIG. 13 illustrates a display of a user interface according to a sliding operation of an electronic device according to an embodiment of the disclosure;

FIG. 14 illustrates a display of a user interface according to a sliding operation of an electronic device according to an embodiment of the disclosure;

FIG. 15 illustrates a user interface displayed on an electronic device according to an embodiment of the disclosure;

FIG. 16 illustrates a user interface according to an embodiment of the disclosure;

FIG. 17 illustrates a user interface according to an embodiment of the disclosure;

FIG. 18 illustrates a user interface according to an embodiment of the disclosure;

FIG. 19 illustrates a user interface according to an embodiment of the disclosure;

FIG. 20 illustrates a user interface according to an embodiment of the disclosure; and

FIG. 21 illustrates a user interface according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

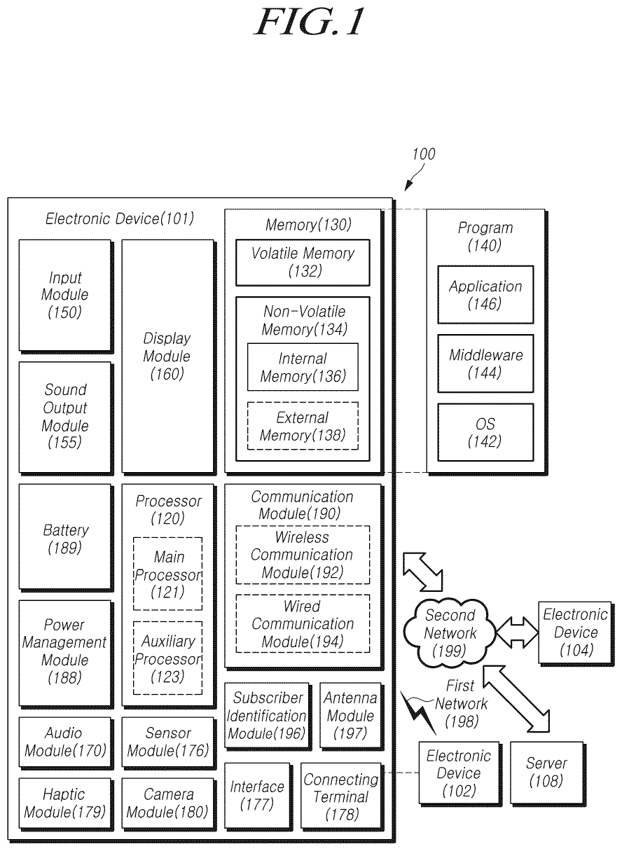

An electronic device according to various embodiments may have a flexible structure. The structures or types of electronic devices shown in FIGS. 1, 2, 3A, 3B, 4A, and 4B are merely examples, and the scope of the embodiments is not limited to a specific structure or type of electronic device. The structure or type of the electronic device shown in the disclosure may be modified, altered, or applied in various ways. The technical features of the disclosure are not limited to specific embodiments of the disclosure, but may rather be applied to all types of electronic devices (e.g., smartphones, mobile devices, laptops, tablets, or wearable devices) including a flexible display and their operation methods.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 is a block diagram illustrating an electronic device in a network environment according to an embodiment of the disclosure.

Referring to FIG. 1, an electronic device 101 in a network environment 100 may communicate with at least one of an external electronic device 102 via a first network 198 (e.g., a short-range wireless communication network), or an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment of the disclosure, at least one (e.g., the connecting terminal 178) of the components may be omitted from the electronic device 101, or one or more other components may be added in the electronic device 101. According to an embodiment of the disclosure, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor configured to detect a touch, or a pressure sensor configured to measure the intensity of a force generated by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state.

According to an embodiment of the disclosure, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5^{th} generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment of the disclosure, the antenna module 197 may include one antenna including a radiator formed of a conductor or conductive pattern formed on a substrate (e.g., a printed circuit board (PCB)). According to an embodiment of the disclosure, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment of the disclosure, other parts (e.g., radio frequency integrated circuit (RFIC)) than the radiator may be further formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or health-care) based on 5G communication technology or IoT-related technology.

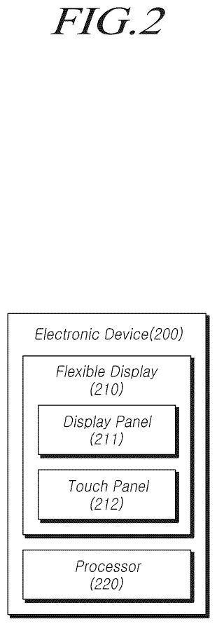

FIG. 2 is a block diagram illustrating an electronic device according to an embodiment of the disclosure.

Referring to FIG. 2, an electronic device 200 according to an embodiment may include a flexible display 210 and a processor 220.

The flexible display 210 and the processor 220 included in the electronic device 200 may be electrically and/or operatively connected to each other to exchange signals (e.g., commands or data) with each other.

In FIG. 2, components of the electronic device 200 may correspond to the components of the electronic device 101 illustrated in FIG. 1. For example, the flexible display 210 may include the display module 160 of FIG. 1 or may correspond to the display module 160. The processor 220 may correspond to the processor 120, the main processor 121, or the auxiliary processor 123 of FIG. 1.

In an embodiment of the disclosure, the flexible display 210 may include a display panel 211 and a touch panel 212. For example, the display panel 211 and the touch panel 212 may be stacked in a layer structure or may be integrally implemented. For example, the touch panel 212 may include at least one of a portion for detecting a user touch input or a portion for detecting a touch input by a stylus pen.

For example, the flexible display 210 may correspond to a flexible display 330.

The flexible display 210 may include a physical (or hardware) available area that may be used for display and/or touch. At least a portion of the available area of the flexible display 210 may be withdrawn from the housing of the electronic device 200 or exposed to the outside of the electronic device 200 to be used. For example, the available area of the flexible display 210 may include a first area (always exposed area) and a second area (selectively exposed area). As another example, the available area of the flexible display 210 may include a plurality of areas that may be withdrawn step by step according to a mechanical state (or a sliding state).

The flexible display 210 may have a structure in which, among the available area, the size of an area (hereinafter, referred to as an “exposed or shown area”) that is drawn out of the housing of the electronic device 200 or exposed to the outside of the electronic device 200 is changed (e.g., extended or reduced) by the sliding operation. A touch function and/or a display function may be provided through the exposed area of the flexible display 210. The touch function may be a function of detecting a touch input. The display function may be a function of displaying a user interface.

The electronic device 200 may have a sliding structure for changing (e.g., extending or shrinking) the size of the exposed area of the available area of the flexible display 210 by changing the mechanical state (or a slide state).

As the mechanical state of the electronic device 200 is changed, the size of the exposed area of the available area of the flexible display 210 may be changed (e.g., extended or reduced).

For example, as the mechanical state of the electronic device 200 is switched from a first state (e.g., the slide-in state, the folded state, or the reduced state) to a second state (e.g., the slide-out state, the unfolded state, or the extended state), the exposed area of the flexible display 210 may be extended. As another example, as the mechanical state of the electronic device 200 is switched from the second state (e.g., the slide-out state, the unfolded state, or the extended state) to the first state (e.g., the slide-in state, the folded state, or the reduced state), the exposed area of the flexible display 210 may be reduced.

The processor 220 may include at least one processor. For example, the processor 220 may include at least one of an application processor (AP) (e.g., the main processor 121) and a communication processor (CP) (e.g., the auxiliary processor 123). The processor 220 may execute/control various functions supported by the electronic device 200. The processor 220 may execute an application and control various types of hardware by executing code written in a programming language stored in memory (e.g., the memory 130 of FIG. 1).

The processor 220 may provide a display function and/or a touch function by driving (or controlling) the flexible display 210. The processor 220 may include a touch integrated circuit for driving the touch panel 212 and/or a display integrated circuit for driving the display panel 211.

The processor 220 may obtain a measurement value of at least one sensor (e.g., a distance sensor) in the sensor module (not shown). The processor 220 may detect the sliding distance of the flexible display 210 through the at least one sensor.

In an embodiment of the disclosure, the processor 220 may selectively execute the sliding-out operation according to the user's intention.

For example, in the first state (e.g., the slide-in state) of the electronic device 200, a portion of the flexible display 210 may be inserted into the housing of the electronic device 200 so as not to be exposed to the outside of the electronic device 200, and another portion may be withdrawn out of the housing so as to be exposed to the outside of the electronic device 200. The processor 220 may display, through the flexible display 210, a user interface inquiring whether to perform a sliding-out operation for extending the exposed area of the flexible display 210, and may perform the sliding-out operation according to a user input to the user interface. For example, the user interface may include a yes or no menu for selecting whether to execute the sliding-out operation. The processor 220 may perform a sliding-out operation in response to a user input to the user interface. When the yes menu item is selected in the user interface, a sliding-out operation may be executed. When the no menu item is selected in the user interface, the sliding-out operation may be canceled, and the slide state of the electronic device 200 may be maintained as it is. As the sliding-out operation is executed, the electronic device 200 may be switched to the second state (e.g., a slide-out state, an unfolded state, or an extended state). As the electronic device 200 is switched from the first state to the second state, the exposed area of the flexible display 210 may be extended.

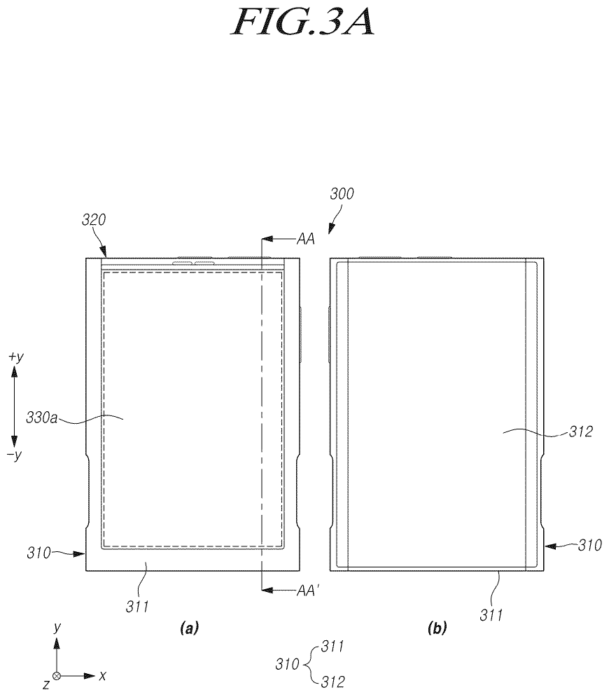

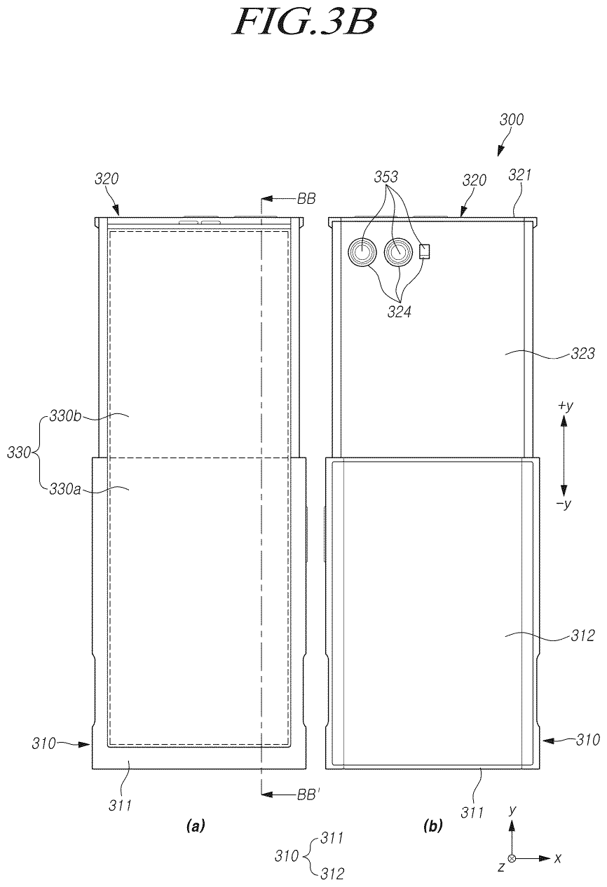

FIG. 3A illustrates a first state of an electronic device according to an embodiment of the disclosure.

FIG. 3B illustrates a second state of an electronic device according to an embodiment of the disclosure.

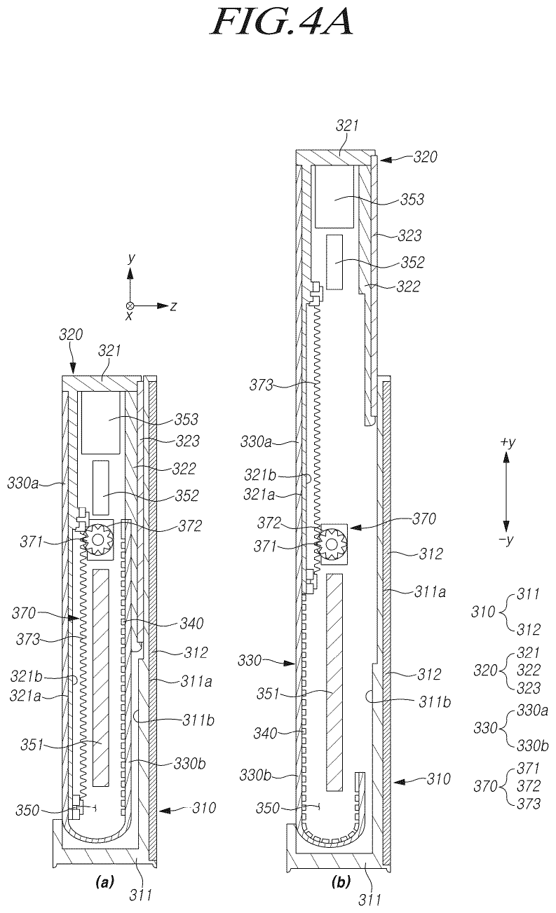

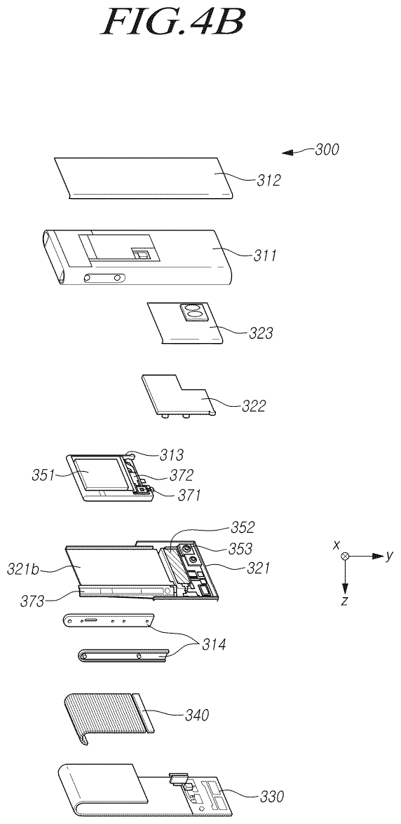

FIG. 4A is a cross-sectional view illustrating an electronic device according to an embodiment of the disclosure.

In the following description, the first state refers to a state in which the second housing (e.g., a second housing 320) of the electronic device slides in the direction (e.g., −y direction) toward the first housing (e.g., a first housing 310). The first state may be referred to by other various terms, such as “drawn-in state”, “closed state”, “reduced state”, or “slide-in state”. Further, the “second state” refers to a state in which the second housing (e.g., the second housing 320) of the electronic device slides in a direction (e.g., the +y direction) away from the first housing (e.g., the first housing 310). The first state may be referred to by other various terms, such as “drawn-out state”, “open state”, “extended state” or “slide-out state”.

Parts (a) and (b) of FIG. 3A illustrate a front surface and a rear surface, respectively, of an electronic device in a first state, and parts (a) and (b) of FIG. 3B illustrate a front surface and a rear surface, respectively, of an electronic device in a second state. Referring to FIG. 4A, part (a) of FIG. 4A illustrates a cross section taken along line AA-AA′ of the electronic device 200 of part (a) of FIG. 3A, and part (b) of FIG. 4A illustrates a cross section taken along line BB-BB′ of the electronic device 200 of part (a) of FIG. 3B. The electronic device 200 of FIGS. 3A, 3B, and 4A may represent an electronic device corresponding to the electronic device 101 of FIG. 1.

Referring to FIGS. 3A, 3B, and 4A, an electronic device 200 according to an embodiment may include a first housing 310 (e.g., a base housing), a second housing 320 (e.g., a slide housing), a flexible display 330 (e.g., an extendable display or a stretchable display), and a bendable member 340 (e.g., an articulated hinge module or a multi-bar assembly).

In an embodiment of the disclosure, while the electronic device 200 transitions from the first state to the second state or from the second state to the first state, the second housing 320 may slide with respect to the first housing 310 within a defined distance range along a defined direction (e.g., the Y-axis direction) (moved in the +y direction or the −y direction).

In an embodiment of the disclosure, the flexible display 330 may include a first display area 330a supported by the second housing 320 and a second display area 330b extending from the first display area 330a and supported by the bendable member 340.

In an embodiment of the disclosure, the first display area 330a supported by the second housing 320 may remain exposed to the outside to be visually recognized regardless of whether the electronic device 200 is in the first state or the second state.

In an embodiment of the disclosure, when the electronic device 200 is in the first state, at least a portion of the bendable member 340 and the display area 330b corresponding thereto may be received in an inner space 350 of the electronic device 200. In this case, the display area 330b may not be exposed from the outside.

In an embodiment of the disclosure, when the electronic device 200 transitions from the first state to the second state (e.g., the second housing 320 moves in the +y direction), at least a portion of the bendable member 340 may move to form the same plane as at least a portion of the second housing 320.

In an embodiment of the disclosure, when the electronic device 200 transitions from the first state to the second state (e.g., the second housing 320 moves in the +y direction), the display area 330b may be exposed to the outside together with the display area 330a.

In an embodiment of the disclosure, when the electronic device 200 transitions from the second state to the first state (e.g., the second housing 320 moves in the-y direction), the display area 330b disposed to be visually recognizable from the outside while being in the second state and a corresponding portion of the bendable member 340 supporting the same may be wound and moved to be received back into the inner space 350 of the electronic device 200. As the second housing 320 slides in a designated direction (e.g., +y or −y direction) with respect to the first housing 310 and the electronic device 200 transitions between the first state and the second state, at least a portion of the second display area 330b may transition between a state in which it is visually recognizable from the outside and a state in which it is not visually recognizable, and the size of the screen exposed to the outside of the flexible display 330 may be extended or reduced.

Referring to FIGS. 3A, 3B, and 4A, the first housing 310 of the electronic device 200 according to an embodiment may include a first support member 311 configured to surround a rear surface, both side surfaces, and/or a lower surface of the inner space 350 of the electronic device 200, and a rear plate 312 covering the rear surface of the first support member 311.

In an embodiment of the disclosure, a rear plate 312 may be seated on one surface 311a of the first support member 311 facing the outside opposite to the inner space 350 of the electronic device 200. In an embodiment of the disclosure, a battery 351 and a portion of a driving module 370 may be disposed in the inner space 350 on the other surface 311b opposite to the one surface 311a of the first support member 311. In an embodiment of the disclosure, one side of the first support member 311 may be formed in an open shape to receive at least a portion of the second housing 320.

The second housing 320 of the electronic device 200 according to an embodiment may include a second support member 321 configured to surround a front surface, both side surfaces, and/or an upper surface of the inner space 350 of the electronic device 200, a rear cover 322 coupled to the second support member 321, and a slide cover 323.

In an embodiment of the disclosure, one surface 321a of the second support member 321 facing the outside opposite to the inner space 350 of the electronic device 200 may face and support the second display area 330a of the flexible display 330.

In an embodiment of the disclosure, a printed circuit board 352 on which various electronic components (e.g., the processor 120 of FIG. 1) of the electronic device 200 are disposed, a camera module 353, and/or a sensor module (not shown) may be disposed in the inner space 350 on another surface 321b opposite to the one surface 321a of the second support member 321.

The camera module 353 (e.g., the camera module 188) according to an embodiment may include one or more lenses, an image sensor, and/or an image signal processor.

In an embodiment of the disclosure, when the electronic device 200 is in the second state, the camera module 353 may be exposed to the outside of the electronic device 200 through the rear cover 322 of the second housing 320 and an opening 324 formed in the slide cover 323.

In an embodiment of the disclosure, an opening may not be formed in the first support member 311 and/or the rear plate 322, and the camera module 353 may be covered by the first support member 311 and/or the rear plate 312 while the electronic device 200 is in the first state, so as not to be exposed to the outside.

In an embodiment of the disclosure, when the electronic device 200 is in the first state, the camera module 353 may be exposed to the outside of the electronic device 200 through openings (not shown) formed in the first support member 311 and the rear plate 322, respectively, and openings 324 formed in the rear cover 322 and the slide cover 323 of the second housing 320.

The sensor module (not shown) according to an embodiment may detect an operational state of the electronic device 200 or an external environmental state of the electronic device 200, and generate an electrical signal or data value corresponding thereto. For example, the sensor module may include at least one of a proximity sensor, an ultrasonic sensor, a gesture sensor, a gyro sensor, an atmospheric pressure sensor, a magnetic sensor, an acceleration sensor, a grip sensor, a color sensor, an infrared sensor, a biometric sensor, a temperature sensor, or a humidity sensor.

In an embodiment of the disclosure, at least some sensor modules of the electronic device 200 may be visually exposed to the outside through a partial area of the flexible display 330.

The rear cover 322 according to an embodiment may be disposed to face the other surface 321b of the second support member 321 with various electronic components of the inner space 350 of the electronic device 200 interposed therebetween and may be coupled to the second support member 321.

The slide cover 323 according to an embodiment may be disposed on one surface of the rear cover 322 opposite to the inner space 350.

In an embodiment of the disclosure, the slide cover 323 may be coupled to one surface of the rear cover 322 and/or the second support member 321 to form an outer surface of the second housing 320 together with the second support member 321.

Referring to FIG. 4A, the electronic device 200 according to an embodiment may include a driving module 370 that drives a sliding movement of the second housing 320. In an embodiment of the disclosure, the driving module 370 may include a pinion gear 371, a motor 372 coupled to the pinion gear 371, and a rack gear 373 engaged with the pinion gear 371.

In an embodiment of the disclosure, at least some components (e.g., the pinion gear 371 and the motor 372) of the driving module 370 may be disposed in the inner space 350.

In an embodiment of the disclosure, while the second housing 320 may slide in a direction (e.g., the +y direction) away from the first housing 310 and transitions to the second state, the pinion gear 371 and the motor 372 may maintain positions with respect to the first housing 310.

In an embodiment of the disclosure, another portion of the driving module 370, e.g., the rack gear 373, may be disposed in the inner space 350 of the electronic device 200 on one surface 321b of the second support member 321 of the second housing 320.

In an embodiment of the disclosure, when the second housing 320 slides and transitions to the second state, the rack gear 373 may move with respect to the first housing 310 while maintaining the position with respect to the second housing 320.

In an embodiment of the disclosure, the motor 372 may receive power from the battery 351 to provide a driving force for sliding movement of the second housing 320.

In an embodiment of the disclosure, the pinion gear 371 may be coupled to the motor 372 and may be rotated clockwise or counterclockwise by the driving force provided from the motor 372.

In an embodiment of the disclosure, the rack gear 373 may be engaged with the pinion gear 371 to linearly reciprocate in the −y direction or the +y direction as the pinion gear 371 rotates.

In an embodiment of the disclosure, if the pinion gear 371 rotates counterclockwise in part (a) of FIG. 4A, e.g., the rack gear 373 may move in the +y direction. If the rack gear 373 moves in the +y direction, the second housing 320 coupled to the rack gear 373 may move in the +y direction. As the second housing 320 moves along the +y direction, the second display area 330b may be exposed to the outside and the area of the display 330 visually recognizable from the outside of the electronic device 200 may be increased.

In an embodiment of the disclosure, when the pinion gear 371 rotates clockwise in FIG. part (b) of 4A, e.g., the rack gear 373 may move in the −y direction. If the rack gear 373 moves in the −y direction, the second housing 320 coupled to the rack gear 373 may move in the −y direction. As the second housing 320 moves along the −y direction, the second display area 330b may be wound and received into the inner space 350, and the area of the display 330 visually recognizable from the outside of the electronic device 200 may be reduced.

In an embodiment of the disclosure, when the electronic device 200 detects a trigger event causing the sliding movement of the second housing 320, the motor 372 of the driving module 370 may be driven. In an embodiment of the disclosure, the trigger event may include various user inputs, e.g., a touch input to an operation control affordance object displayed on the flexible display 330 of the electronic device 200, a gesture input detected from various sensors, a voice input, and/or an operation input to a predetermined physical button (not shown) disposed on the electronic device 200. In an embodiment of the disclosure, the trigger event may include a predetermined operating state (e.g., detection of a predetermined condition by the sensor module) inside a predetermined device.

FIG. 4B is an exploded perspective view illustrating an electronic device according to an embodiment of the disclosure.

Referring to FIG. 4B, in an embodiment of the disclosure, the rear plate 312 may be disposed on the rear surface of the first support member 311. The first support member 311 and the rear plate 312 may be coupled to each other to form the first housing 310.

In an embodiment of the disclosure, the rear cover 322 and the slide cover 323 may be disposed on the rear surface of the second support member 321. The second support member 321, the rear cover 322, and the slide cover 323 may be coupled to each other to form the second housing 320.

In an embodiment of the disclosure, the printed circuit board 352 and the camera module 353 may be disposed on one surface (one surface 321b facing the rear cover 322) of the second support member 321.

In an embodiment of the disclosure, the rack gear 373 may be disposed on one side of the second support member 321 along the Y-axis direction. In an embodiment of the disclosure, when the second housing 320 including the second support member 321, the rear cover 322, and the slide cover 323 slides with respect to the first housing 310, the printed circuit board 352, the camera module 353, and the rack gear 373 disposed on the second support member 321 may move together with the second housing 320.

In an embodiment of the disclosure, an additional support member 313 may be disposed between one surface 321b facing the rear cover 322 of the second support member 321 and one surface 311b facing the inner space 350 of the first support member 311.

In an embodiment of the disclosure, the additional support member 313 may include the battery 351, the motor 372, and the pinion gear 371 disposed in a recess and/or a hole formed in the additional support member 313.

In an embodiment of the disclosure, when the second housing 320 slides with respect to the first housing 310, the additional support member 313, and the battery 351, the motor 372, and the pinion gear 371 formed on the additional support member 313, together with the first housing 310, may maintain the positions with respect to the first housing 310 without moving.

In an embodiment of the disclosure, the bendable member 340 may extend from the second support member 321 and may be disposed to surround a portion of the additional support member 313 in the inner space 350 on one surface 311b of the first support member 311.

In an embodiment of the disclosure, the flexible display 330 may be disposed to surround one surface 321a of the second support member 321 and the bendable member 340. A portion of the flexible display 330, e.g., the first display area 330a, may be supported by one surface 321a of the second support member 321, and another portion, e.g., the second display area 330b, may be supported by the bendable member 340.

In an embodiment of the disclosure, the bendable member 340 may include a plurality of bars coupled to each other, and may have a shape corresponding to the shape of the second display area 330b. In an embodiment of the disclosure, the bendable member 340 may move together with the flexible display 330 as the second housing 320 moves.

In an embodiment of the disclosure, when the electronic device transitions from the first state to the second state, the second display area 330b of the flexible display 330 may be moved to form the state in which it is received in the inner space 350 to be hidden from outside, so as to be exposed to the outside while forming the same plane as the first display area 330a. In an embodiment of the disclosure, when the electronic device transitions from the first state to the second state, the bendable member 340 supporting the second display area 330b may move together with the second display area 330b.

In an embodiment of the disclosure, the electronic device 200 may include a pair of guide rails 314 for guiding the movement of the bendable member 340 and the flexible display 330, which moved together with the movement of the second housing 310.

In an embodiment of the disclosure, each of the pair of guide rails 314 may be disposed on two opposite sides with the bendable member 340 and the flexible display 330 interposed therebetween along the X-axis direction. According to an embodiment of the disclosure, the guide rail 314 may be coupled to the additional support member 313 or the first support member 311.

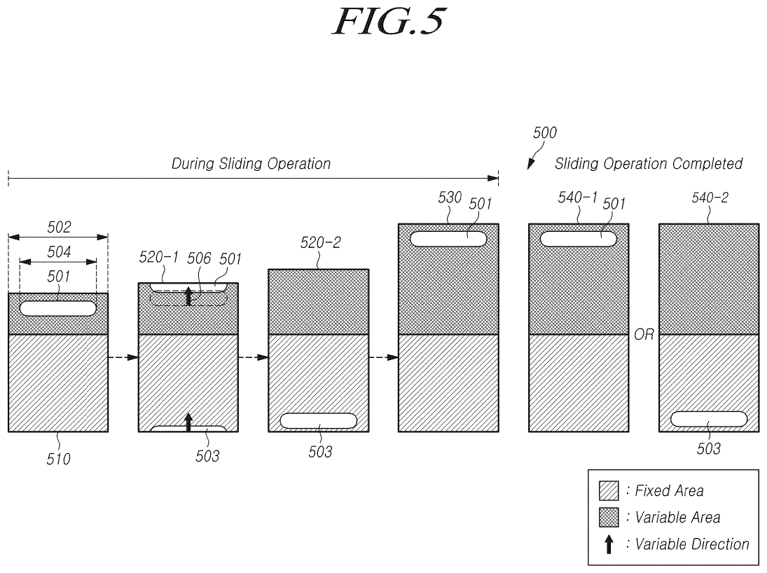

FIG. 5 illustrates a change in a user interface 500 according to an embodiment of the disclosure.

Referring to FIG. 5, an operation in which a variable area of a display of an electronic device is extended in a variable direction according to a user's operation is sequentially illustrated. The electronic device illustrated in FIG. 5 may include a device corresponding to the electronic device 101 and the electronic device 200.

In an embodiment of the disclosure, an electronic device 300 may include a fixed area and a variable area. The variable area may refer to an area that may be extended or reduced in the display area of the electronic device 300. For example, the variable area may mean an area corresponding to the second display area 330b. The fixed area may refer to an area of the display area of the electronic device 200 that is fixed without being extended or reduced. For example, the fixed area may mean an area corresponding to the first display area 330a. The fixed area may be a display area corresponding to an area including a CPU, a battery, a motor, or the like, of the electronic device.

In an embodiment of the disclosure, the user interface displayed on the electronic device 200 may include a first UI object 501. The first UI object 501 and a second UI object 503 may refer to components for identifying a user input for executing a specific function in an application executed in the electronic device 200. For example, the UI object 501 and the second UI object 503 may include an icon button, a text button, a tap button, and an Internet address bar (e.g., a uniform resource locator (URL) bar) included in the application.

In an embodiment of the disclosure, the first UI object 501 may refer to a UI element positioned in the variable area, and the second UI object 503 may refer to a UI element displayed in the fixed area, as a UI element for performing the same function as the first UI object 501. In an embodiment of the disclosure, as the variable area is extended, the UI objects 501 and 503 may be moved and displayed in the variable direction.

In an embodiment of the disclosure, a width 504 of the UI object may have a value smaller than the width 502 of the variable area. For example, the width 504 of the UI object may be less than half (½) of the width 502 of the variable area. Further, e.g., the width 504 of the UI object may be larger than half (½) of the width 502 of the variable area but smaller than the width 502 of the variable area.

In an embodiment of the disclosure, as the electronic device performs the sliding operation, the user interface displayed on the electronic device may be changed, such as 510, 520-1, 520-2, and 530. The sliding operation of the electronic device may refer to an operation of extending the variable area of the electronic device. The sliding operation of the electronic device may refer to an operation in which the size of the variable area of the electronic device is increased. The sliding operation of the electronic device may be initiated by identifying a user input through an object for performing screen extension (e.g., an object displayed on a user interface or another hardware key).

In the case of a UI element positioned in the variable area, since the physical position thereof changes while the variable area is being extended, displaying the UI element in the fixed area may be more effective in stably identifying the user input than fixing the UI element in the variable area. According to an embodiment of the disclosure, the UI function element may be temporarily or permanently rearranged in the fixed area while the screen is being extended to stably identify the user input through the UI function element (e.g., the first UI object 501).

In an embodiment of the disclosure, the electronic device may rearrange the UI object in a first section in the entire time duration required for screen extension, and may identify the user input through the rearranged UI object in the remaining second section. The first section and the second section may be determined according to a defined proportion in the entire time duration. For example, when the entire time duration required for screen extension is 1.2 seconds and the proportion is preset to 25%, the first section may refer to a section of 0 second to 0.3 second, and the second section may refer to a section of 0.3 second to 1.2 second (a total of 0.9 seconds). The electronic device may identify a user input through a UI object (e.g., the first UI object 501 and the second UI object 503) in both the first section and the second section.

In an embodiment of the disclosure, a user interface 510 may include a user interface displayed before the sliding operation of the electronic device is initiated. Before the sliding operation is initiated, the first UI object 501 may be displayed in the variable area.

In an embodiment of the disclosure, the user interfaces 520-1, 520-2, and 530 may include a user interface in a process of extending the screen after a sliding operation of the electronic device is initiated. The user interfaces 520-1 and 520-2 may refer to user interfaces displayed while the electronic device is performing an operation for extending the screen and the UI object is rearranged. The user interface 530 may refer to a user interface displayed when the electronic device is performing an operation for extending the screen and relocation of a UI object is completed.

In an embodiment of the disclosure, the user interfaces 520-1 and 520-2 may include a user interface displayed on the electronic device in the first section. While the screen is extended in the first section, the position of the first UI object 501 may be moved (506) to the upper end of the screen. The upper end of the screen may refer to one end of the variable area in the variable direction. The user interfaces 520-1 and 520-2 may be changed so that the first UI object 501 gradually disappears from the screen while moving to the upper end of the screen. Further, e.g., while the screen is extended, the second UI object 503 may be displayed in such a manner that it appears from the lower end of the fixed area in the variable direction.

In an embodiment of the disclosure, in the second section, the first UI object 501 may not be displayed in the variable area, but only the second UI object 503 may be displayed in the fixed area. Although not shown in the drawings, the first UI object 501 may be duplicated and displayed in the variable area in the second section.

In an embodiment of the disclosure, the electronic device 200 may display a user interface based on the width 504 of the first UI object 501 and the width 502 of the variable area. For example, when the width 504 of the first UI object 501 is less than or equal to ½ of the width 502 of the variable area, the electronic device 200 may display the first UI object 501 in both the variable area and the fixed area. Further, e.g., when the width 504 of the first UI object 501 is larger than ½ of the width 502 of the variable area, the first UI object 501 may be provided only in the fixed area.

In an embodiment of the disclosure, the user interfaces 510, 520-1, 520-2, and 530 may identify a user input through the first UI object 501 or the second UI object 503. Although not illustrated, the user interfaces 510, 520-1, 520-2, and 530 may include a UI object fixedly displayed at the same position as the initial position (e.g., a position in the user interface 510) of the first UI object 501 in addition to the first UI object 501 moving to the upper end of the screen.

In an embodiment of the disclosure, the user interfaces 540-1 and 540-2 may refer to user interfaces displayed after the screen extension is completed. After the screen extension is completed, the electronic device may display the user interface 540-1 or the user interface 540-2. When the first UI object 501 is displayed in the variable area, like displayed before the screen extension, without displaying the second UI object 503 relocated temporarily while the screen is being extended, the user interface 540-1 may be displayed. If the display of the second UI object 503 that has been temporarily relocated is maintained while the screen is being extended, the user interface 540-2 may be displayed.

In an embodiment of the disclosure, the electronic device 200 may determine whether to maintain the display of the second UI object 503 relocated in the fixed area. For example, the electronic device 200 may determine whether to maintain the display of the second UI object 503 based on whether the user input is identified through the second UI object 503 in the first section and the second section. For example, when the electronic device 200 identifies the user input through the second UI object 503 in the first section and the second section, the electronic device 200 may display the user interface 540-1. For example, when the electronic device 200 does not identify any user input through the second UI object 503 in the first section and the second section, the electronic device 200 may display the user interface 540-2. For example, when the electronic device 200 identifies a user input through the first UI object 501 in the first section and the second section, the electronic device may display the user interface 540-2.

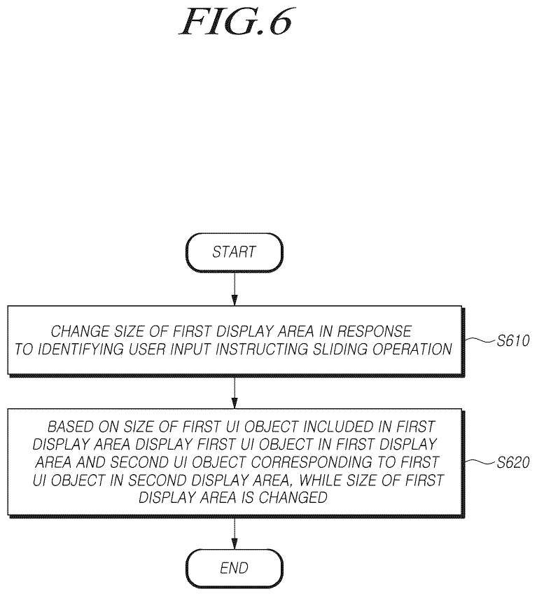

FIG. 6 illustrates an operation flow of an electronic device according to an embodiment of the disclosure.

Referring to FIG. 6, the electronic device may include a device corresponding to the electronic device 101 of FIG. 1 and the electronic device 200 of FIG. 2.

According to an embodiment of the disclosure, in operation S610, the electronic device may change the size of the first display area in response to identifying a user input indicating a slide operation.

In an embodiment of the disclosure, the first display area may refer to a size-variable area of the display of the electronic device. In an embodiment of the disclosure, the second display area may refer to a size-fixed area of the display of the electronic device.

In an embodiment of the disclosure, the sliding operation may refer to an operation in which the rollable display is extended through the motor included in the electronic device.

In an embodiment of the disclosure, the user input indicating the sliding operation may be identified through a hardware input component (e.g., a physical button) of the electronic device or a component (e.g., a specific icon for performing a sliding function) displayed on a user interface.

In an embodiment of the disclosure, the electronic device may change the size of the first display area for a defined time. For example, when the time required for the electronic device to change the size of the first display area is set to 1.2 seconds, the electronic device may extend or reduce the first display area for 1.2 seconds.

In an embodiment of the disclosure, as the sliding operation is performed, the first display area may be changed from the first state (e.g., the slide-in state) to the second state (e.g., the slide-out state).

In an embodiment of the disclosure, the first display area may be extended in the first direction that is a direction in which the display is drawn out.

In an embodiment of the disclosure, the first display area may include at least one first UI object. The first UI object may not be an object for simply displaying content, such as an image, a text, or the like, but may include an object for identifying a user input to perform a specific function related to the UI. For example, the first UI object may include an address bar, a function icon of an app bar, and the like.

In an embodiment of the disclosure, when the first UI object is present over the first display area and the second display area, the electronic device may determine that the first UI object is included in the first display area.

In an embodiment of the disclosure, the first UI object may include a floating action button (FAB). The FAB may refer to a first UI object having a shape similar to an icon for performing a specific function and having a floating shape, unlike the surrounding area, to induce a user input.

According to an embodiment of the disclosure, in operation S620, the electronic device, based on the size of the first UI object included in the first display area, may display the first UI object in the second display area and the first display area while the size of the first display area is changed.

In an embodiment of the disclosure, based on a value corresponding to the width of the first UI object and a value corresponding to the width of the first display area, the electronic device may display the first UI object in the second display area and the first display area while the size of the first display area is changed.

In an embodiment of the disclosure, when the value corresponding to the width of the first UI object is equal to or less than a defined proportion (e.g., ½) of the value corresponding to the width of the first display area, the electronic device may display, in duplicate, the first UI object in the first display area and the second UI object in the first display area while the size of the first display area changes.

In an embodiment of the disclosure, when the value corresponding to the width of the first UI object is larger than a defined proportion (e.g., ½) of the value corresponding to the width of the first display area, the electronic device may display the second UI object in the second display area while the size of the first display area changes.

In an embodiment of the disclosure, the electronic device may display the UI object in such a manner that the UI object moves from the first display area toward the first direction. The first direction may refer to a direction in which the first display area is extended.

In an embodiment of the disclosure, the electronic device may display the second UI object corresponding to the first UI object in the second display area. The second UI object may refer to a UI object having the same shape as the first UI object, and for performing the same function.

In an embodiment of the disclosure, the electronic device may display the second UI object in such a manner that the second UI object appears in the first direction from a lower end of the electronic device, i.e., at an end in a direction opposite to the first direction in the electronic device.

In an embodiment of the disclosure, the UI object (e.g., the first UI object and the second UI object) may move only in the first time section which is a part of the total time required for the sliding operation. The first time interval may be determined according to a preset proportion. For example, assuming that the time required for the sliding operation of the first display area is 1.2 seconds, when the preset proportion is 25%, the first time section may include a time section of 0 second to 0.3 second. After the first time section, the second time section may refer to a time section in which the UI object does not move but the first display area is still extending. For example, assuming that the time required for the sliding operation of the first display area is 1.2seconds, when the preset proportion is 25%, the second time section may include a time section between 0.3 second and 1.2 second.

In an embodiment of the disclosure, the operation of moving the UI object may include a UI object, and may move by a first value corresponding to a defined proportion of a height of the area for distinguishing other contents displayed on the UI and the height of the UI object. The first UI object may be displayed in such a manner that the first UI object moves by the first value and then gradually disappears, rather than moving up to the upper end of the screen, i.e., an end in the first direction of the electronic device. For example, when the height of the area for distinguishing other contents is A and the height of the UI object is B, the first value may be a value corresponding to ⅓(A+B).

In an embodiment of the disclosure, after the first UI object moves by the first value, the electronic device may display an upper limit line for displaying the position of the first UI object. The upper limit line displayed by the electronic device may indicate an upper limit to which the first UI object may move.

In an embodiment of the disclosure, the electronic device may display the first UI object in such a manner that the first UI object gradually disappears after moving to the upper limit line.

In an embodiment of the disclosure, the electronic device may display the second UI object in such a manner that the second UI object gradually appears from a lower end of the electronic device, i.e., an end in a direction opposite to the first direction of the electronic device.

In an embodiment of the disclosure, the electronic device may display a lower limit line for displaying the position of the second UI object. The lower limit line displayed by the electronic device may indicate a point where the second UI object starts to appear.

In an embodiment of the disclosure, the electronic device may display the upper limit line for displaying the position of the first UI object while simultaneously displaying the lower limit line for displaying the position of the second UI object.

In an embodiment of the disclosure, the electronic device may increase the transparency of the first UI object as the first UI object moves to the upper end of the electronic device. For example, transparency may be increased to display the first UI object to gradually disappear as it moves to the upper end.

In an embodiment of the disclosure, when the electronic device identifies a user input through the second UI object while performing the sliding operation, the electronic device may maintain the display of the second UI object in the second display area after the sliding operation is completed.

In an embodiment of the disclosure, when the electronic device does not identify any user input through the second UI object while performing the sliding operation, the electronic device may release the display of the second UI object displayed in the second display area after the sliding operation is completed, and may display the first UI object in the first display area. In other words, the first UI object may be restored and displayed again at a position corresponding to the position in the first display area before the sliding operation.

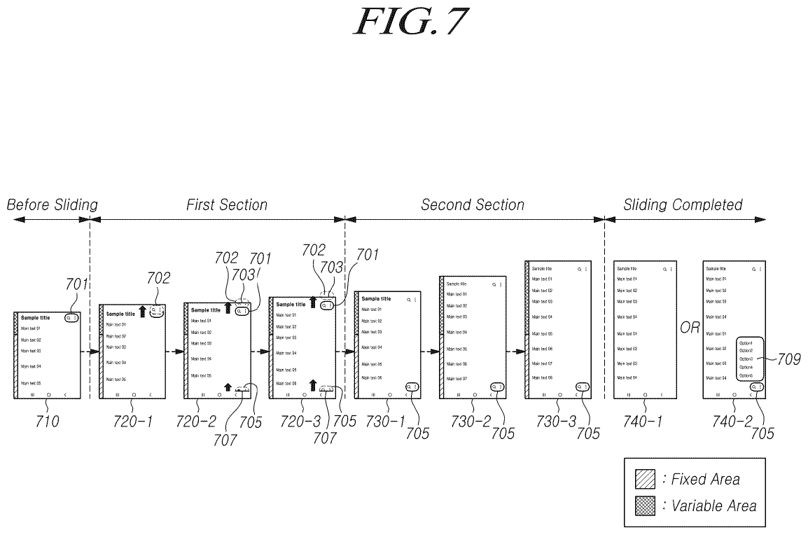

FIG. 7 illustrates a display of a user interface according to a sliding operation of an electronic device according to an embodiment of the disclosure.

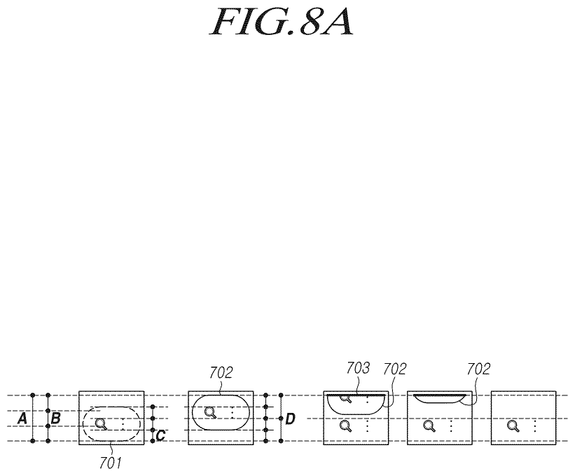

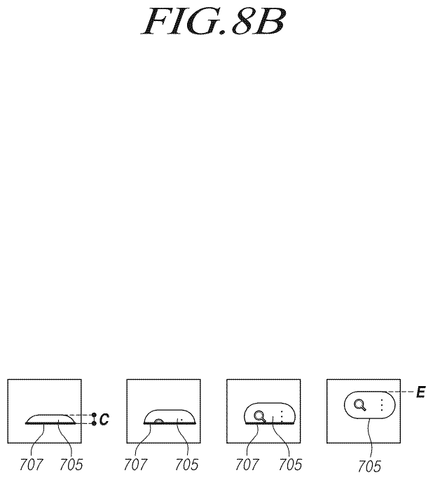

FIG. 8A illustrates a movement of a first UI object in a user interface according to FIG. 7. FIG according to an embodiment of the disclosure.

FIG. 8B illustrates a movement of a second UI object in a user interface according to FIG. 7 according to an embodiment of the disclosure.

The electronic device and the user interface illustrated in FIGS. 7, 8A, and 8B may refer to an example of the user interface described with reference to FIGS. 5 and 6.

Referring to FIG. 7, a user interface 710 may refer to a user interface displayed on the electronic device before a sliding operation of the electronic device is initiated. User interfaces 720-1, 720-2, and 720-3 may refer to user interfaces displayed on the electronic device in the first section among sections in which the display area is changed according to the sliding operation of the electronic device. The user interfaces 730-1, 730-2, and 730-3 may refer to user interfaces displayed on the electronic device in the second section among the sections in which the display area changes according to the sliding operation of the electronic device. User interfaces 740-1 and 740-2 may refer to user interfaces displayed on the electronic device after the sliding operation of the electronic device is completed.

Referring to FIG. 7, an example of a user interface displayed when the width of a UI object 701 is less than or equal to half the width of the display area is illustrated. Since the width of the UI object 701 is less than or equal to half the width of the display, the electronic device may display the same in the variable area (the first display area) and the fixed area (the second display area) in duplicate.

In an embodiment of the disclosure, the user interfaces 720-1, 720-2, and 720-3 sequentially illustrate a process of changing the user interface as the second display area of the electronic device is extended in the first section. A first UI object 702 is an object corresponding to the UI object 701 and may have a form of FAB. The first UI object 702 may be displayed in such a manner as to gradually move to the upper end of the screen, and an upper limit line 703 of the movement may be displayed together. The first UI object may move only up to the upper limit line 703, and may be displayed as gradually disappearing from the upper limit line. Since the width of the UI object is ½ or less of the width of the display area, even if the second UI object 702 disappears, the UI object 701 may be displayed in the first display area as it is.

Referring to FIG. 8A, the distance to which the first object 702 moves may be determined based on a value corresponding to a defined proportion of the height of the area in which the UI object 701 is displayed and a value corresponding to a defined proportion of the height of the first object 702. For example, the first object 702 may move by B+C which is the sum of B, which is ⅓ of the height A of the area including the UI object 701, and C, which is ⅓ of the height of the first UI object 702, and the upper limit line 703 may be displayed after it moves by B+C. While the first object 702 moves to point D (center of the area including the UI object 701), the movement speed may remain the same.

In an embodiment of the disclosure, the time required for the first object 702 to move by B+C may be a time corresponding to a defined proportion of the first section. For example, when the total time required to extend the first display area is 1.2 seconds and the first section is 0 second to 0.3 second, which is 25% of 1.2 seconds, the first object may move by B+C for 0 second to 0.18 second, which is 60% of 0.3 seconds. In the remaining section of 0.18 second to 0.3 second, the first object 702 may be displayed as gradually disappearing.

In an embodiment of the disclosure, while the first UI object 702 moves, the display of the UI object 701 may be maintained as it is.

Referring to FIG. 8B, in an embodiment of the disclosure, in the first section, the first UI object 702 may be displayed as gradually disappearing through the upper end of the screen while simultaneously displaying a second UI object 705 as gradually appearing at the lower end of the screen. The second UI object 705 may be generated and displayed from a lower limit line 707 and, after moving by a defined distance, remain displayed as it is. For example, when the first object 702 moves by B, the second object 705 may not appear, and when the first object 702 additionally moves by C, the second object 705 may appear in the second display area by C. Thereafter, when the second UI object 705 reaches E, the second object 705 may no longer move.

In an embodiment of the disclosure, the user interfaces 730-1, 730-2, and 730-3 may include the UI object 701 and the second UI object 705, and the movement of the UI object may no longer occur. However, since the screen (e.g., the first display area and the variable area) is still being extended, the amount of displayed content may increase.

In an embodiment of the disclosure, the electronic device may display the user interface 740-1 or the user interface 740-2 after the sliding operation is completed. The electronic device may display the user interface 740-1 or the user interface 740-2 depending on whether the user input is identified through the second UI object 705 in the first section or the second section. For example, when a user input is identified through the second UI object 705 in the first section or the second section, the electronic device may display the user interface 740-2. Further, e.g., when a user input is not identified through the second UI object 705 in the first section or the second section, the electronic device may display the user interface 740-1. Further, e.g., when a user input is identified through the first object 702 in the first section or the second section, the electronic device may display the user interface 740-2.

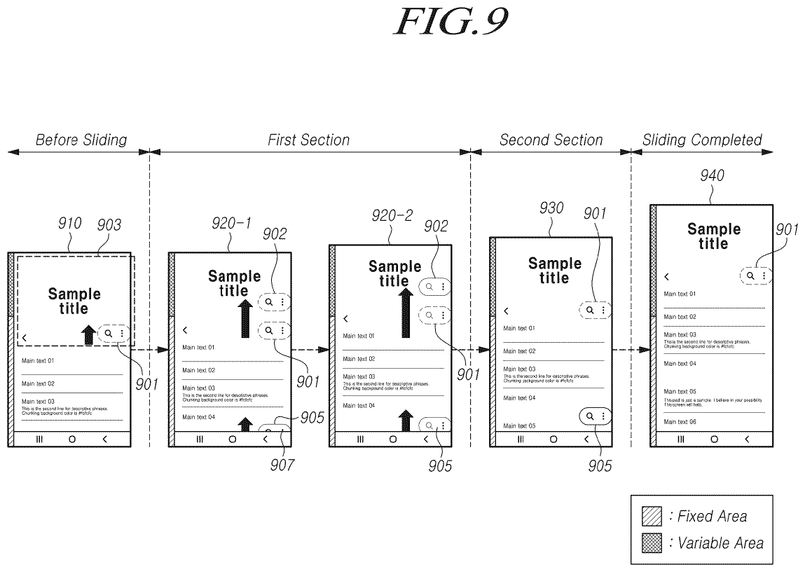

FIG. 9 illustrates a display of a user interface according to a sliding operation of an electronic device according to an embodiment of the disclosure.

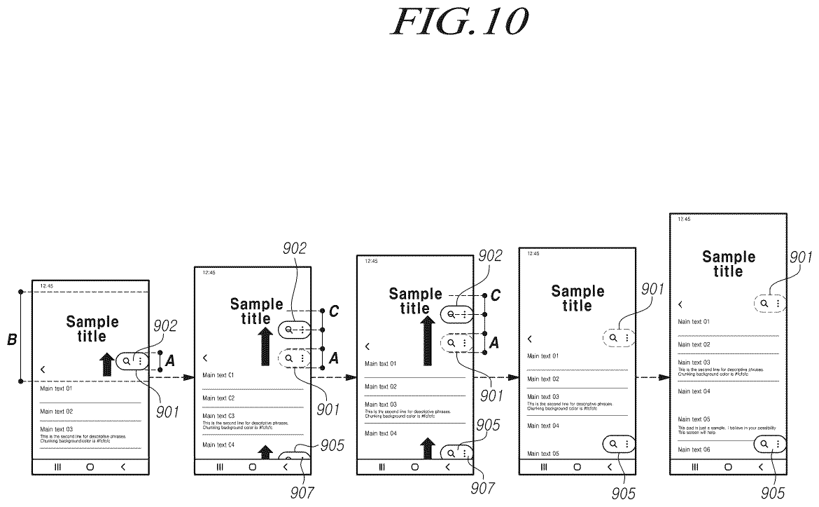

FIG. 10 illustrates a change in a first UI object in a user interface according to FIG. 9 according to an embodiment of the disclosure.

Referring to FIGS. 9 and 10, since the width of a UI object 901 is less than or equal to half the width of the display, the electronic device may display the same in the variable area (the first display area) and the fixed area (the second display area) in duplicate. In describing FIG. 9, the description corresponding to the part described in the previous drawings (e.g., FIGS. 5, 6, and 7) may be omitted.

In an embodiment of the disclosure, a user interface 910 may refer to a user interface displayed before a sliding operation of the electronic device is initiated. In an embodiment of the disclosure, user interfaces 920-1 and 920-2 may refer to user interfaces displayed on the electronic device in the first section 903. In an embodiment of the disclosure, a user interface 930 may refer to a user interface displayed on the electronic device in the second section. In an embodiment of the disclosure, a user interface 940 may refer to a user interface displayed on the electronic device after the sliding operation of the electronic device is completed.

In an embodiment of the disclosure, even when a portion of the area (expandable app bar area) including the UI object belongs to the first display area (variable area), the electronic device may determine that the UI object is included in the first display area. For example, an area including the UI object 901 (an area indicated as “Sample title”) is displayed over the second display area, which is the fixed area, and the first display area, which is the variable area. In this case, the electronic device may determine that the UI object 901 is in the first display area, and may perform an operation corresponding to FIG. 6.

Since the area in which the UI object 901 is displayed is displayed relatively wide over the second display area and the first display area, the distance by which the UI object moves may increase. In this case, the user interface may be displayed in such a manner as to adjust the transparency of the UI object displayed together with the movement of the UI object.

In an embodiment of the disclosure, in the first section, as the first display area of the electronic device is extended, a first UI object 902 may move to the upper end of the screen. The operation of moving the first UI object 902 to the upper end of the screen may be performed to correspond to the operation of moving the first UI object 702 to the upper end of the screen as described in FIG. 7.

In an embodiment of the disclosure, in the first section, as the first display area of the electronic device is extended, a second UI object 905 may be displayed as appearing from the lower end of the screen. The operation of displaying the second UI object 905 may be performed to correspond to the manner of displaying the second UI object 705 of FIG. 7.

In an embodiment of the disclosure, as the first display area of the electronic device is extended in the first section, the transparency of the first UI object 902 may be increased. By increasing the transparency of the first UI object 902, the user interface may be displayed in such a manner that the first UI object 902 disappears from the screen.

Referring to FIG. 10, B may refer to the height B of the area including the UI object 901, and A may refer to the height of the first UI object 902. As the first UI object 902 moves to the upper end of the screen, the transparency of the first UI object 902 may increase. If the first UI object 902 reaches point C, which is three times point A, the transparency becomes 100% and it may be displayed as if disappearing from the screen.

Referring to FIG. 10, the distance to which the first object 902 moves may be determined based on a value corresponding to a defined proportion of the height of the area in which the UI object 901 is displayed and a value corresponding to a defined proportion of the height of the first object 902. For example, the first object 902 may move by B+C which is the sum B, which is ⅓ of the height A of the area including the UI object 901, and C, which is ⅓ of the height of the first UI object 902. While the first object 902 moves to the center of the area including the UI object 901, the movement speed may remain the same.

In an embodiment of the disclosure, the time required for the first object 902 to move by B+C may be a time corresponding to a defined proportion of the first section. For example, when the total time required to extend the first display area is 1.2 seconds and the first section is 0 second to 0.3 second, which is 25% of 1.2 seconds, the first object may move by B+C for 0 second to 0.18 second, which is 60% of 0.3 seconds. In the remaining section of 0.18 second to 0.3 second, the first object 902 may be displayed as gradually disappearing.

In an embodiment of the disclosure, while the first UI object 902 moves, the display of the UI object 901 may be maintained as it is.

Referring to FIG. 10, in an embodiment of the disclosure, the first UI object 902 may gradually disappear to the upper end of the screen in the first section, and the second UI object 905 may gradually appear at the lower end of the screen. The second UI object 905 may be generated and displayed from a lower limit line 907 and, after moving by a defined distance, remain displayed as it is.

In an embodiment of the disclosure, the user interfaces 930 may include the UI object 901 and the second UI object 905, and the movement of the UI object may no longer occur. However, since the screen (e.g., the first display area and the variable area) is still being extended, the amount of displayed content may increase.

In an embodiment of the disclosure, the electronic device may display the user interface 940 after the sliding operation is completed. The electronic device may display the user interface 940 depending on whether the user input is identified through the second UI object 905 in the first section or the second section. For example, when a user input is not identified through the second UI object 905 in the first section or the second section, the electronic device may display the user interface 940. Further, for example, although not shown in the drawings, when a user input is identified through the second UI object 905 in the first section or second section, the electronic device may display a user interface (e.g., the user interface 740-2) in the form in which the second UI object 905 is included in the second display area.

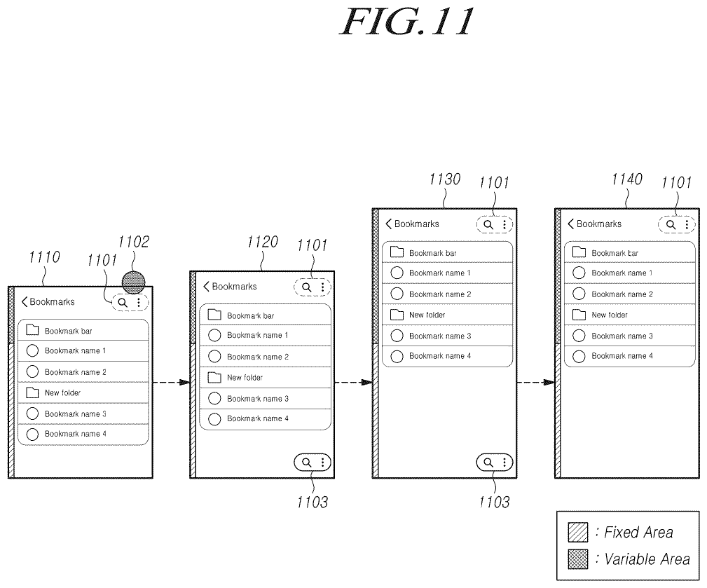

FIG. 11 illustrates a display of a user interface according to a sliding operation of an electronic device according to an embodiment of the disclosure.

FIG. 11 illustrates a UI object being displayed on a user interface moves when a display area of an electronic device displaying a user interface for an Internet bookmark menu screen is extended. The display of the user interface of the electronic device disclosed in FIG. 11 corresponds to the contents described with reference to FIGS. 7 and 9, but the type of the displayed UI object may be directly different as an Internet bookmark bar.

Referring to FIG. 11, in an embodiment of the disclosure, a user interface 1110 may refer to a user interface before screen extension is initiated. Screen extension may be performed when a user input is identified through a hardware component included in the electronic device or an object 1102 for initiating screen extension of the user interface.

In an embodiment of the disclosure, a user interface 1120 may refer to a user interface displayed when the sliding operation of the electronic device is initiated, i.e., when the first display area (variable area) is extended. Referring to the user interface 1120, as the sliding operation of the electronic device is initiated, the first display area may be extended, and accordingly, the UI object displayed in the first display area may be displayed in the second display area.

In an embodiment of the disclosure, a user interface 1130 and a user interface 1140 may refer to user interfaces after the UI object is displayed in the second display area and the screen extension is terminated. The electronic device may display the user interface 1130 or the user interface 1140 after the sliding operation of the electronic device is completed, based on whether the user input is identified through a second UI object 1103 while the electronic device performs the sliding operation. For example, when the electronic device receives a user input through the second UI object 1103 while performing the sliding operation, the electronic device may display the user interface 1130. In other words, the display of the second UI object 1103 may be maintained. Further, e.g., when the electronic device does not receive a user input through the second UI object 1103 while performing the sliding operation, the electronic device may display the user interface 1140. In other words, the display of the second UI object 1103 may be released, and the originally displayed UI object 1101 may be displayed.

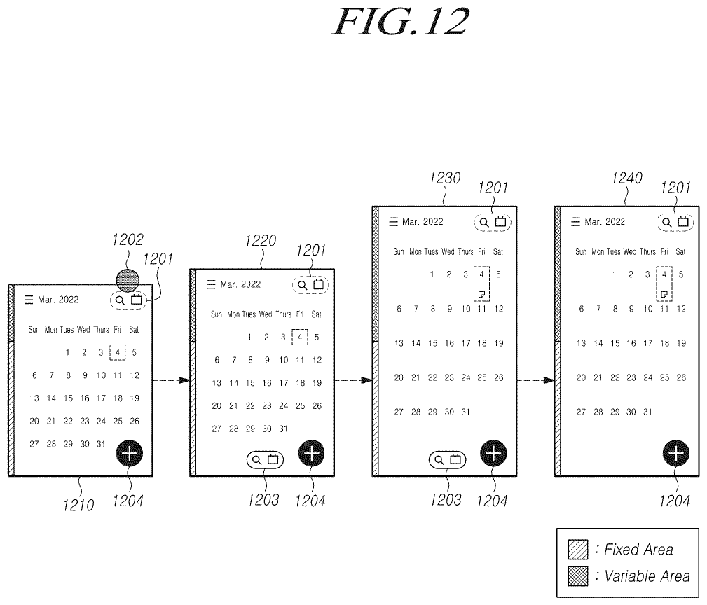

FIG. 12 illustrates a display of a user interface according to a sliding operation of an electronic device according to an embodiment of the disclosure.

FIG. 12 illustrates a UI object being displayed on a user interface moves when a display area of an electronic device displayed in a calendar app is extended. The display of the user interface of the electronic device disclosed in FIG. 12 corresponds to the contents described with reference to FIGS. 7, 9, and 11, but the type of the displayed UI object may be related to the function execution of the calendar app.

Referring to FIG. 12, in an embodiment of the disclosure, a user interface 1210 may refer to a user interface before screen extension is initiated. Screen extension may be performed when a user input is identified through a hardware component included in the electronic device or an object 1202 for initiating screen extension of the user interface.

In an embodiment of the disclosure, a user interface 1220 may refer to a user interface displayed when the sliding operation of the electronic device is initiated, i.e., when the first display area (variable area) is extended. Referring to the user interface 1220, as the sliding operation of the electronic device is initiated, the first display area may be extended, and accordingly, the UI object displayed in the first display area may be displayed in the second display area.

In an embodiment of the disclosure, when a UI object 1204 for performing another function is already displayed in the second display area, a second UI object 1203 may be displayed on the side of the UI object 1204.

In an embodiment of the disclosure, a user interface 1230 and a user interface 1240 may refer to user interfaces after the second UI object 1203 is displayed in the second display area and the screen extension is terminated. The electronic device may display the user interface 1230 or the user interface 1240 after the sliding operation of the electronic device is completed, based on whether the user input is identified through the second UI object 1203 while the electronic device performs the sliding operation. For example, when the electronic device receives a user input through the second UI object 1203 while performing the sliding operation, the electronic device may display the user interface 1230. In other words, the display of the second UI object 1203 may be maintained. Further, e.g., when the electronic device does not receive a user input through the second UI object 1203 while performing the sliding operation, the electronic device may display the user interface 1240. In other words, the display of the second UI object 1203 may be released, and the originally displayed UI object 1201 may be displayed.

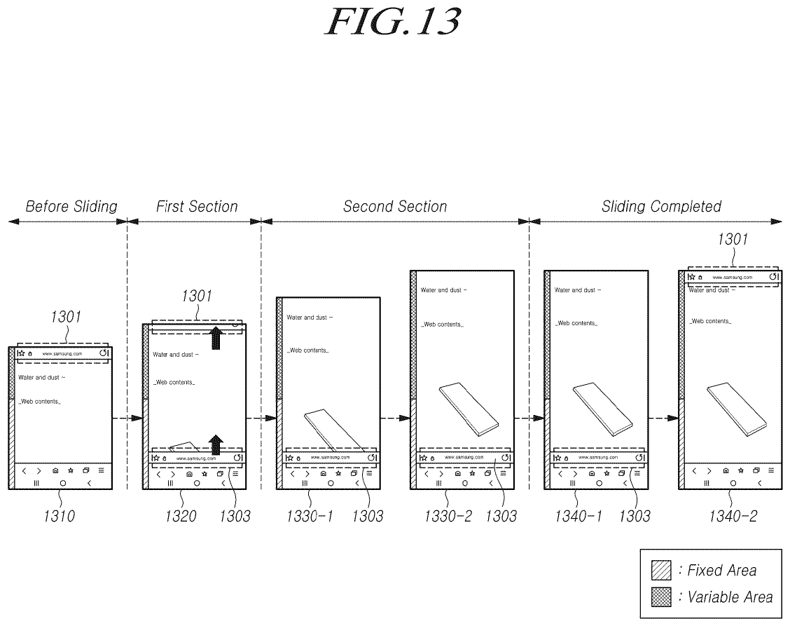

FIG. 13 illustrates a display of a user interface according to a sliding operation of an electronic device according to an embodiment of the disclosure.

Referring to FIG. 13, the electronic device and the user interface may correspond to the electronic device and the user interface described with reference to FIGS. 5 and 6.

FIG. 13 illustrates a user interface including an Internet address bar. The width of the Internet address bar may be larger than half the width of the display area. The second display area may refer to a size-fixed area in the display area of the electronic device, and the first display area may refer to an area which is size-variable by a sliding operation in the display area of the electronic device.

In an embodiment of the disclosure, a user interface 1310 may include a user interface displayed on the electronic device before the sliding operation of the electronic device is initiated. In the user interface 1310, a UI object 1301 (e.g., an Internet address bar) may be included in the first display area.

In an embodiment of the disclosure, a user interface 1320 may include a user interface displayed on the electronic device in a first time section after the sliding operation of the electronic device is initiated. The first time section may refer to a time section in which the UI object moves in the entire time duration in which the sliding operation of the electronic device is performed, and the first time section may refer to a time section corresponding to a defined proportion in the entire time duration when the sliding operation is performed. For example, assuming that the time required for the sliding operation of the electronic device to be initiated and completed is 1.2 seconds, and when the proportion of the movement time of the UI object is set to 25% of the entire time duration, the first time section may refer to a time section between 0 second and 0.3 second.

In an embodiment of the disclosure, as the first display area is extended in the user interface 1320, the first UI object (Internet address bar) 1301 may move in the extension direction of the first display area. The first UI object 1301 may be displayed in such a manner that the first UI object 1301 disappears toward the upper end of the screen, i.e., an end in the extension direction in the electronic device.

In an embodiment of the disclosure, it may be displayed in such a manner that in the user interface 1320, the first display area is extended, and the first UI object 1301 disappears through the upper end of the screen and, simultaneously, a second UI object 1303 appears from the lower end of the second display area in the extension direction. The lower end of the second display area may refer to the opposite end of the upper end described above.

In an embodiment of the disclosure, while the second UI object 1303 is displayed as appearing in the second display area in the user interface 1320, a lower limit line indicating the position of the second UI object 1303 may be displayed.

In an embodiment of the disclosure, user interfaces 1330-1 and 1330-2 may include a user interface displayed on the electronic device in the second time section. After the movement of the UI object (e.g., the first UI object 1301 and the second UI object 1303) is completed in the first time section, the movement of the UI object may not occur, but only the extension of the first display area may occur in the second time section.

In an embodiment of the disclosure, in the user interfaces 1330-1 and 1330-2, only the second UI object may be displayed in the second display area, and the first UI object 1301 may disappear through the upper end of the screen and may no longer be displayed in the first display area.

In an embodiment of the disclosure, user interfaces 1340-1 and 1340-2 may include a user interface displayed after the sliding operation of the electronic device is completed. The electronic device may display the user interface 1340-1 or the user interface 1340-2 based on whether there is a user input identified through the second UI object 1303 in the first time section or the second time section. For example, when the electronic device identifies the user input through the second UI object 1303 in the first time section or the second time section, the electronic device may display the user interface 1340-1 after the sliding operation is completed. Display of the second UI object 1303 may be maintained in the user interface 1340-1. In other words, the Internet address bar moved to the lower end may be displayed as it is. Further, e.g., when the electronic device does not identify the user input through the second UI object 1303 in the first time section or the second time section, the electronic device may display the user interface 1340-2 after the sliding operation is completed. The user interface 1340-2 may release the display of the second UI object 1303 and may display the first UI object 1301 again. In other words, the Internet address bar may be displayed again at the upper end of the first display area.

In an embodiment of the disclosure, the user input identified through the second UI object 1303 may include an operation of tapping the Internet address bar. If the tap input is identified in the second UI object 1303, the electronic device may maintain the display of the second UI object 1303 displayed in the second display area and may execute the search window.

In an embodiment of the disclosure, the user input identified through the second UI object 1303 may include an operation of swiping the Internet address bar. If the swipe input is identified in the second UI object 1303, the electronic device may maintain the display of the second UI object 1303 and may perform a movement operation between tabs.

In an embodiment of the disclosure, the user input identified through the second UI object 1303 may include a long press on the Internet address bar. If a long press in the second UI object 1303 is identified, the electronic device may display the second UI object 1303 in the second display area as it is even after the screen extension is completed.

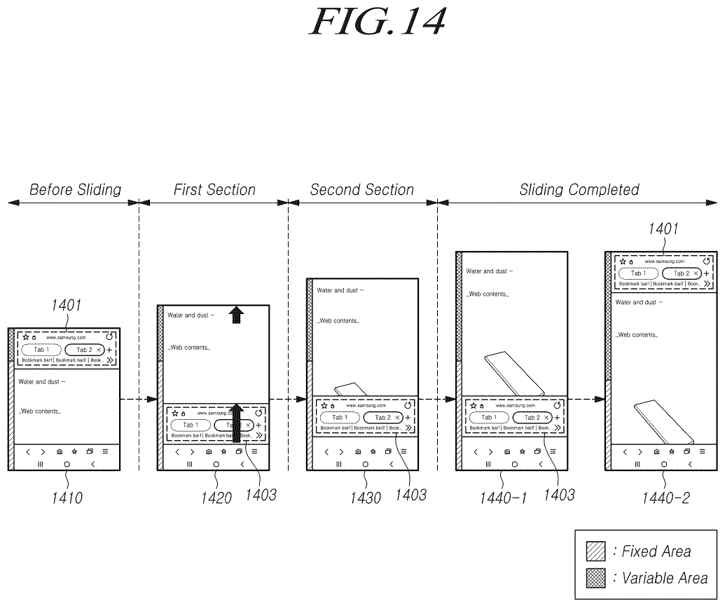

FIG. 14 illustrates a display of a user interface according to a sliding operation of an electronic device according to an embodiment of the disclosure.

The user interface illustrated in FIG. 14 may correspond to the operation of displaying the user interface of the electronic device described with reference to FIG. 13.

Referring to FIG. 14, in an embodiment of the disclosure, a user interface 1410 displayed before a sliding operation of an electronic device is initiated may include a first UI object area 1401 including various function icons of an App bar including an Internet address bar in a first display area.

In an embodiment of the disclosure, as the sliding operation of the electronic device is initiated, the size of the first display area may be increased.

In an embodiment of the disclosure, a user interface 1420 may include a user interface displayed on the electronic device in the first time section, and a user interface 1430 may include a user interface displayed on the electronic device in the second time section.

In an embodiment of the disclosure, as the size of the first display area of the electronic device is increased, the first UI object area 1401 may be displayed in such a manner that it disappears from the upper end of the screen of the first display area in the extension direction (variable direction) of the first display area. At the same time, the second UI object area having the same shape as the first UI area and including the function icons of the Internet address bar and the App bar capable of performing the same function as the first UI area may be displayed as appearing in the extension direction from the lower end of the screen of the second display area.

In an embodiment of the disclosure, the user interfaces 1440-1 and 1440-2 may include a user interface displayed after the sliding operation of the electronic device is completed. The electronic device may display the user interface 1440-1 or the user interface 1440-2 based on whether there is a user input identified through a second UI object area 1403 in the first time section or the second time section. For example, when the electronic device identifies the user input through the second UI object area 1403 in the first time section or the second time section, the electronic device may display the user interface 1440-1 after the sliding operation is completed. Display of the second UI object area 1403 may be maintained in the user interface 1440-1. In other words, the area including the function icon of the App bar and the Internet address bar moved to the lower end may be displayed as it is. Further, e.g., when the electronic device does not identify the user input through the second UI object area 1403 in the first time section or the second time section, the electronic device may display the user interface 1440-2 after the sliding operation is completed. The user interface 1440-2 may release the display of the second UI object area 1403 and may display the first UI object 1401 again. In other words, the area including the function icon of the App bar and the Internet address bar may be displayed again at the upper end of the first display area.

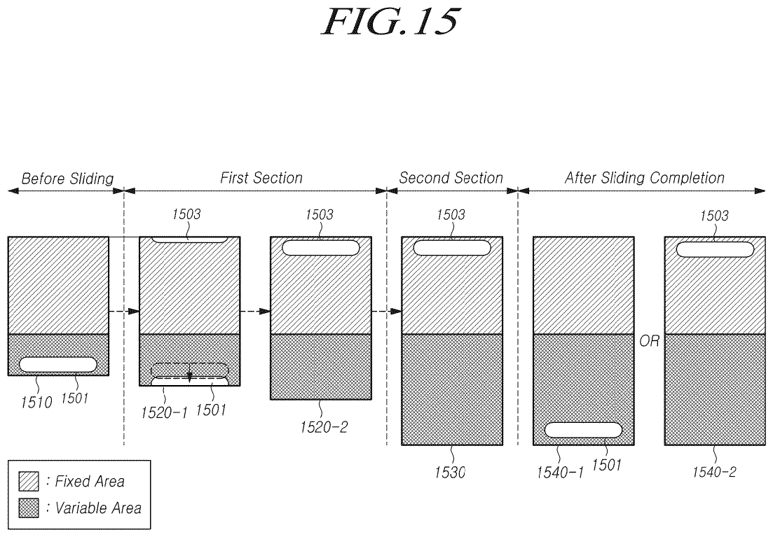

FIG. 15 illustrates a user interface displayed on an electronic device according to an embodiment of the disclosure.

Referring to FIG. 15, the user interface may correspond to the display of the user interface described in FIG. 5. The method for displaying a user interface described with reference to FIG. 15 may relate to an example of a case in which the direction of the electronic device is opposite to the direction of the electronic device in FIG. 5. Alternatively, the method for displaying a user interface described with reference to FIG. 15 may relate to a method for displaying a user interface displayed when the screen is extended downward in the electronic device as illustrated in FIGS. 4A and 4B.

In an embodiment of the disclosure, a user interface 1510 may include a user interface displayed on the electronic device before the sliding operation of the electronic device is initiated. The user interface 1510 may include a first UI object 1501 in a first display area (variable area).

In an embodiment of the disclosure, the user interfaces 1520-1 and 1520-2 may include a user interface displayed in the first section after the electronic device starts the sliding operation. Referring to the user interface 1520-1, the first UI object 1501 displayed in the first display area may move in the variable direction (arrow direction, direction toward the lower end of the screen). Further, the second UI object 1503 may be displayed as gradually appearing at the upper end of the second display area. Referring to the user interface 1520-2, the first UI object 1501 may disappear from the first display area through the lower end of the screen, and the second UI object 1503 may be displayed in the second display area.

In an embodiment of the disclosure, a user interface 1530 may include a user interface displayed on the electronic device in the second section. Referring to the user interface 1530, the first UI object 1501 may no longer be displayed in the first display area, and the second UI object 1503 may be displayed in the second display area.

In an embodiment of the disclosure, user interfaces 1540-1 and 1540-2 may include a user interface displayed on the electronic device after the sliding operation of the electronic device is completed. The user interface 1540-1 may include a user interface displayed when the second UI object 1503 disappears and the first UI object 1501 is displayed again. The user interface 1540-2 may include a user interface displayed when the second UI object 1503 is maintained even after the sliding operation of the electronic device is completed.

In an embodiment of the disclosure, the electronic device may display the user interface 1540-1 or the user interface 1540-2 based on whether there is a user input identified through the second UI object 1503 in the first section or the second section. For example, when a user input is identified through the second UI object 1503 in the first section or the second section, the electronic device may display the user interface 1540-2. Further, e.g., when a user input is not identified through the second UI object 1503 in the first section or the second section, the electronic device may display the user interface 1540-1.

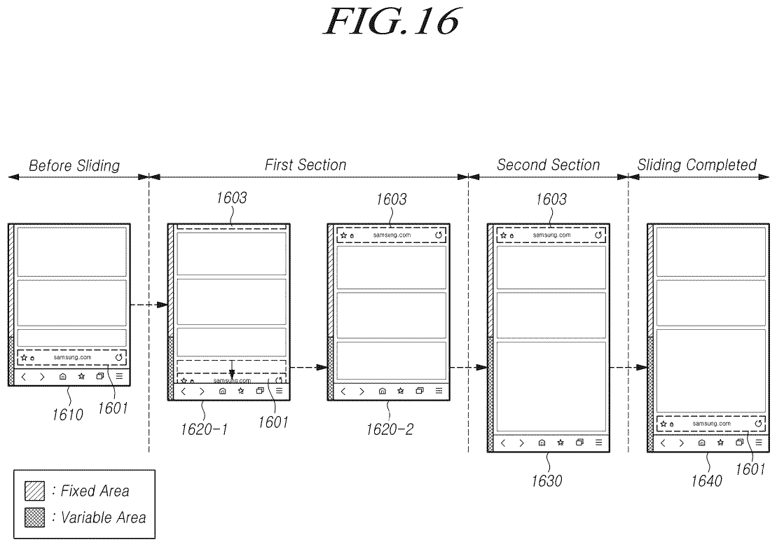

FIG. 16 illustrates a user interface according to an embodiment of the disclosure.

Referring to FIG. 16, a display of a user interface described in FIG. 15 may be included.

In an embodiment of the disclosure, a user interface 1610 may include a user interface displayed on the electronic device before the sliding operation of the electronic device is initiated. A first UI object 1601 may include an Internet address bar area displayed at the lower end of the screen.

In an embodiment of the disclosure, the user interfaces 1620-1 and 1620-2 may include a user interface displayed on the electronic device in the first section. Referring to the user interfaces 1620-1 and 1620-2, as the first display area (variable area) is extended in the first section, the first UI object 1601 displayed in the first display area may disappear to the lower end of the screen, and a second UI object 1603 corresponding to the first UI object 1601 may be displayed in the second display area (fixed area).

In an embodiment of the disclosure, a user interface 1630 may include a user interface displayed on the electronic device in the second section. The user interface 1630 may refer to a user interface displayed after the extension of the first display area is completed and the rearrangement of the UI elements is completed. Referring to the user interface 1630, the first UI object 1601 may not be displayed, and the second UI object 1603 may be displayed in the second display area (fixed area).

In an embodiment of the disclosure, a user interface 1640 may include a user interface displayed after the sliding operation of the electronic device is completed. The user interface 1640 may be an example of a user interface displayed on the electronic device when there is no user input identified through the second UI object 1603 in the first section and the second section. Although not illustrated in the drawings, when a user input (e.g., tap, swipe, long press, or the like) is identified through the second UI object 1603 in the first section or the second section, the electronic device may maintain the display of the second UI object 1603 displayed in the second display area (e.g., the user interface 1630).

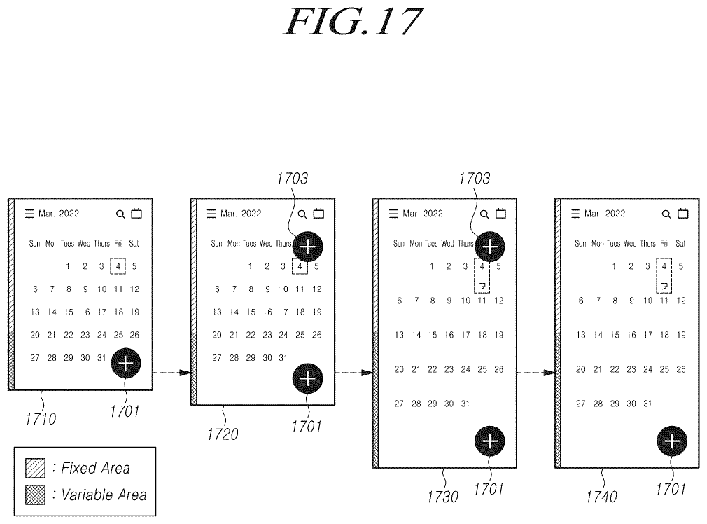

FIG. 17 illustrates a user interface according to an embodiment of the disclosure.

FIG. 17 may mean one regarding a user interface displayed when executing a calendar app, as a type of user interface described in FIG. 15.

Referring to FIG. 17, in an embodiment of the disclosure, a user interface 1710 may include a user interface displayed on the electronic device before the sliding operation of the electronic device is performed. The user interface 1710 may include matters related to the calendar app (e.g., date, day of the week, year, schedule creation, search icon, or the like). The user interface may display a first UI object 1701 for performing a function of adding an event (Add event) in the first display area.

In an embodiment of the disclosure, a user interface 1720 may include a user interface displayed on the electronic device in a first section after the sliding operation of the electronic device is initiated. Referring to the user interface 1720, as the first display area is extended, a second UI object 1703 may be displayed not only in the first display area (variable area) but also in the second display area (fixed area). If the value corresponding to the width of the first UI object is equal to or less than half of the value corresponding to the horizontal width of the first display area, the first UI object and the second UI object may be displayed in duplicate as described above.

In an embodiment of the disclosure, a user interface 1730 may include a user interface displayed on the electronic device in a second section after the sliding operation of the electronic device is initiated. Referring to the user interface 1730, the size of the first display area is increased over the user interface 1720, and the first UI object 1701 and the second UI object 1703 may be displayed in duplicate in the first display area and the second display area, respectively.

In an embodiment of the disclosure, a user interface 1740 may include a user interface displayed on the electronic device after the sliding operation of the electronic device is completed. The user interface 1740 may refer to a user interface displayed when the electronic device fails to identify a user input through the second UI object 1703 in the first section and the second section. Although not shown in the drawings, when the electronic device identifies the user input through the second UI object 1703 in the first section and the second section, the electronic device may maintain the display of the second UI object 1703 as displayed in the user interface 1730.

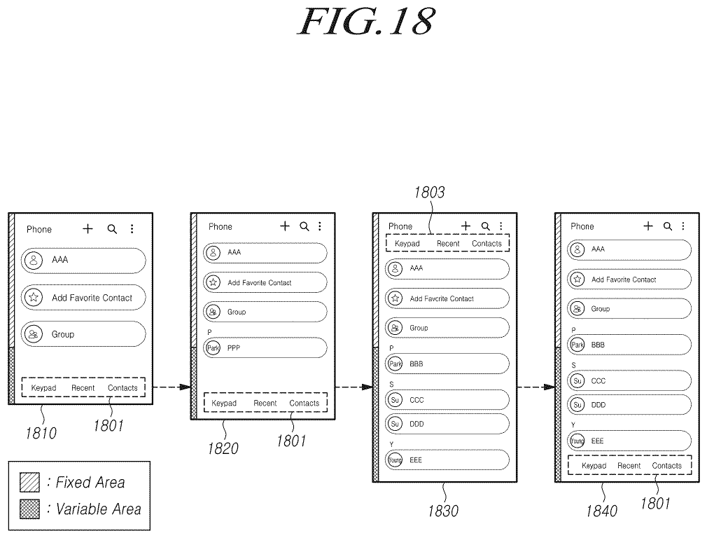

FIG. 18 illustrates a user interface according to an embodiment of the disclosure.

FIG. 18 may mean one regarding a user interface displayed when executing a contacts app, as a type of user interface described in FIG. 15.

Referring to FIG. 18, in an embodiment of the disclosure, a user interface 1810 may include a user interface displayed on the electronic device before the sliding operation of the electronic device is performed. The user interface 1810 may include matters related to the contacts app (e.g., favorite contacts, groups, contact details, or the like). The user interface may display, in the first display area, a first UI object area 1801 including an icon for moving to a keypad, an icon for viewing recent records, and an icon for viewing contacts in detail.

In an embodiment of the disclosure, a user interface 1820 may include a user interface displayed on the electronic device in a first section after the sliding operation of the electronic device is initiated. Referring to the user interface 1820, as the first display area is extended, the first UI object area 1801 may be moved to the lower end of the screen in the first display area (variable area) and displayed. Since the value corresponding to the horizontal width of the first UI object area 1801 is equal to or more than half of the value corresponding to the horizontal width of the first display area, unlike the case of displaying the Add event object of the calendar app of FIG. 17, it may be displayed in such a manner as to gradually disappear from the variable area while gradually appearing in the fixed area, rather than being provided, in duplicate, in the first display area and the second display area.

In an embodiment of the disclosure, a user interface 1830 may include a user interface displayed on the electronic device in a second section after the sliding operation of the electronic device is initiated. Referring to the user interface 1830, as the first display area is extended, the first UI object 1801 may disappear from the first display area, and a second UI object 1803 may be displayed in the second display area.

In an embodiment of the disclosure, a user interface 1840 may include a user interface displayed on the electronic device after the sliding operation of the electronic device is completed. For example, when a user input is not identified through the second UI object 1803 in the first section or the second section, the electronic device may display the user interface 1840. In other words, the UI object relocated in the fixed area may be restored to the variable area again. Further, e.g., although not illustrated in the drawings, when the electronic device identifies a user input through the second UI object area 1803 in the first section or the second section, the display of the second UI object area 1803 may be maintained (e.g., the user interface 1830).

In an embodiment of the disclosure, the user interface 1830 may include a user interface displayed on the electronic device in a second section after the sliding operation of the electronic device is initiated. Referring to the user interface 1830, the size of the first display area is increased over the user interface 1820, and the first UI object 1801 and the second UI object 1803 may be displayed in duplicate in the first display area and the second display area, respectively.

In an embodiment of the disclosure, the user interface 1840 may include a user interface displayed on the electronic device after the sliding operation of the electronic device is completed. The user interface 1840 may refer to a user interface displayed when the electronic device fails to identify a user input through the second UI object 1803 in the first section and the second section. Although not shown in the drawings, when the electronic device identifies the user input through the second UI object 1803 in the first section and the second section, the electronic device may maintain the display of the second UI object 1803 as displayed in the user interface 1830.

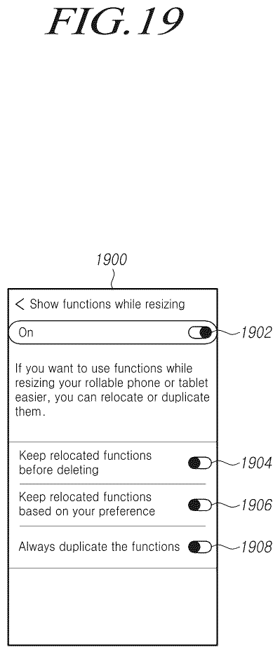

FIG. 19 illustrates a user interface according to an embodiment of the disclosure.

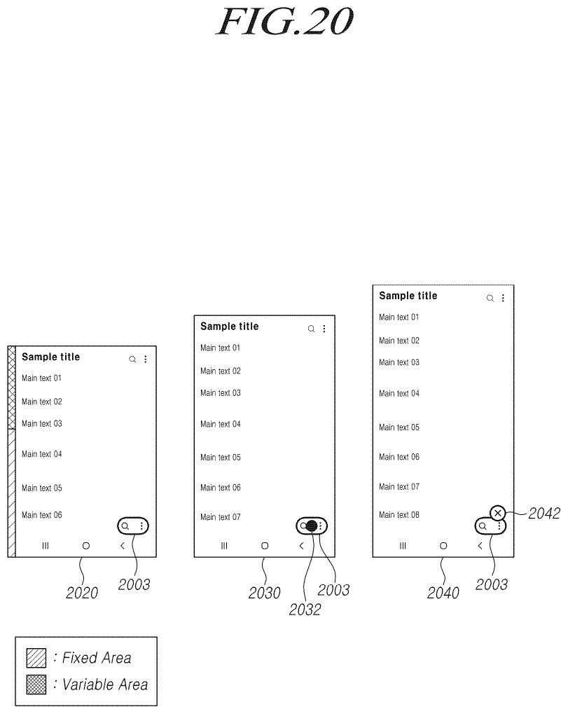

FIG. 20 illustrates a user interface according to an embodiment of the disclosure.

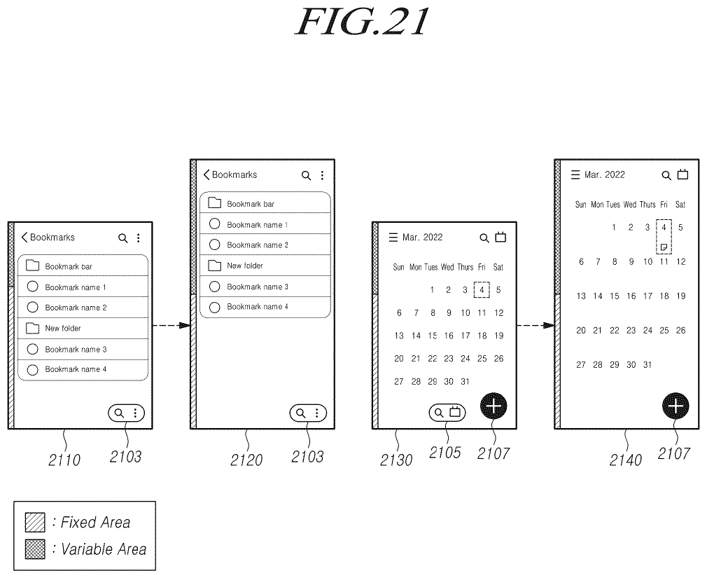

FIG. 21 illustrates a user interface according to an embodiment of the disclosure.

The electronic device illustrated in FIGS. 19 to 21 may include a device corresponding to the electronic device 101 and the electronic device 200. In describing FIGS. 19 to 21, portions overlapping the portions described above in the drawings may be omitted.

Referring to FIG. 19, a user interface 1900 according to an embodiment may include a UI object 1902 for receiving a user input for maintaining display of a duplicated or relocated UI object.

According to an embodiment of the disclosure, when the electronic device identifies a user input for activating the UI object 1902, the electronic device may identify the user input through a UI object 1904, a UI object 1906, and a UI object 1908.

In an embodiment of the disclosure, when the electronic device identifies a user input for activating the UI object 1904, the electronic device may maintain the display of the UI object (e.g., a UI object 2003) displayed in duplicate even after the sliding operation is completed. If a user input for activating the UI object 1904 is received, even after the sliding operation of the electronic device is completed, the display of the UI object displayed in duplicate or relocated may be maintained unless the user directly inputs a user input, such as for deletion. For example, when the electronic device identifies a user input for activating the UI object 1904, the UI object 2003 displayed on a user interface 2020 displayed on the electronic device during the sliding operation may also be displayed on a user interface 2030 and a user interface 2040 displayed on the electronic device after the sliding operation is completed.

In an embodiment of the disclosure, the user interface 2030 may include a UI object 2042 for receiving a user input 2032 for releasing the display of the UI object 2003 displayed in duplicate as the UI object 1902 is activated. For example, when a user input 2032 (e.g., a long press) for releasing the display of the UI object 2003 is identified through the UI object 2003 displayed on the user interface 2030, the user interface 2040 may display the UI object 2042 for releasing the display of the UI object 2003.

In an embodiment of the disclosure, when the electronic device identifies a user input for activating the UI object 1906, the electronic device may maintain the display of the UI object (e.g., the UI object 2003) displayed in duplicate even after the sliding operation is completed, based on the user's use history. When the UI object 1906 is activated, if the number of times the UI object is used exceeds a predetermined number, the display may be maintained even after the sliding operation of the electronic device is completed.

Referring to FIG. 21, in an embodiment of the disclosure, in the case of a UI object 2103 whose use frequency exceeds a predetermined number of times, it may be displayed on a user interface 2120 displayed after the sliding operation is completed, as well as a user interface 2110 displayed during the sliding operation. In an embodiment of the disclosure, in the case of a UI object 2107 whose use frequency exceeds a predetermined number of times, it may be displayed on the user interface 2140 displayed after the sliding operation is completed, as well as a user interface 2130 displayed during the sliding operation. In other words, the UI object displayed in duplicate during the sliding operation may be maintained and displayed even after the sliding operation is completed.

In an embodiment of the disclosure, in the case of a UI object 2105 whose use frequency is smaller than a predetermined number of times, the UI object 2105 which is displayed on the user interface 2130 displayed during the sliding operation may not be displayed on the user interface 2140 displayed after the sliding operation is completed. In other words, in the case of a function that is less frequently used, the duplicate display may not be maintained.

In an embodiment of the disclosure, when the electronic device identifies a user input for activating the UI object 1908, the electronic device may maintain the display of the UI object even during the sliding operation, regardless of the length of the horizontal width of the UI element relative to the display screen of the electronic device. For example, as described above with reference to FIG. 5, the electronic device displays a user interface based on the width of the first UI object and the width of the variable area (e.g., when the width 504 of the first UI object 501 is less than or equal to ½ of the width 502 of the variable area, the electronic device 200 displays the first UI object 501 in both the variable area and the fixed area, or when the width 504 of the first UI object 501 is larger than ½ of the width 502 of the variable area, displays the first UI object 501 only in the fixed area) and, when identifying a user input for activating the UI object 1908, the electronic device may maintain display of the UI object.

A method for operating an electronic device, according to an embodiment of the disclosure, may comprise changing a size of a first display area in response to identifying a user input instructing the electronic device to perform a sliding operation, displaying a first UI object in a first display area and a second UI object corresponding to the first UI object in a second display area while the size of the first display area is changed, based on a size of the first UI object included in the first display area. The first display area may include a size-variable area, and the second display area may include a size-fixed area.

In an embodiment of the disclosure, changing the size of the first display area may include extending the first display area in a first direction.

In an embodiment of the disclosure, displaying the first UI object in the first display area and the second UI object corresponding to the first UI object in the second display area while the size of the first display area is changed, based on the size of the first UI object included in the first display area, may include moving the first UI object from the first display area toward the first direction, and displaying the second UI object corresponding to the first UI object in the second display area.

In an embodiment of the disclosure, displaying the second UI object corresponding to the first UI object in the second display area may include moving and displaying the second UI object in the first direction from an opposite end, in the first direction, of the electronic device.

In an embodiment of the disclosure, the method may further comprise, when a value corresponding to a width of the first UI object is smaller than half of a value corresponding to a width of the first display area, displaying the first UI object in duplicate in the first display area.

In an embodiment of the disclosure, the first UI object may be moved only in a preset first section of an entire time required to perform the sliding operation.

In an embodiment of the disclosure, moving the first UI object may include moving the first UI object by a first value corresponding to a defined proportion of a height of an area including the first UI object and distinguished from the first UI objects displayed on the UI and a height of the first UI object, displaying a line indicating a position of the first UI object at an end of the first UI object in the first direction after moving the first UI object by the first value, and displaying the first UI object to disappear in the first direction after displaying the line.

In an embodiment of the disclosure, the method may further comprise, when a user input is identified through the second UI object while the electronic device performs the sliding operation, maintaining the display of the second UI object in the second display area after the sliding operation is completed.

In an embodiment of the disclosure, the method may further comprise, if no user input is identified through the second UI object while the electronic device performs the sliding operation, releasing the display of the second UI object in the second display area after the sliding operation is completed.

In an embodiment of the disclosure, the first UI object may include an address bar and an icon for performing a specific function.

In an embodiment of the disclosure, the method may further comprise changing transparency of the first UI object according to a moving distance of the first UI object.

An electronic device according to an embodiment of the disclosure may comprise a rollable display including a second display area having a fixed size and a first display area drawn out from or drawn into the electronic device, and at least one processor electrically connected to the rollable display. The at least one processor may be configured to, in response to identifying a user input instructing the electronic device to perform a slide operation, change a size of the first display area, and display a first UI object in the second display area and the first display area while the size of the first display area is changed, based on a size of the first UI object included in the first display area. A size of the second display area may not be changed.

In an embodiment of the disclosure, the at least one processor may be configured to extend the first display area in a first direction to change the size of the first display area.

In an embodiment of the disclosure, the at least one processor may be configured to move and display the first UI object from the first display area toward the first direction, and display a second UI object corresponding to the first UI object in the second display area.

In an embodiment of the disclosure, the at least one processor may be configured to move and display the second UI object in the first direction from an opposite end, in the first direction, of the electronic device.

In an embodiment of the disclosure, the at least one processor may be configured to, when a value corresponding to a width of the first UI object is smaller than half of a value corresponding to a width of the first display area, display the first UI object in duplicate in the first display area.

In an embodiment of the disclosure, the at least one processor may be configured to move the first UI object by a first value corresponding to a defined proportion of a height of an area including the first UI object and distinguished from the first UI objects displayed on the UI and a height of the first UI object, display an upper limit line indicating a position of the first UI object at an end of the first UI object in the first direction after moving the first UI object by the first value, and display the first UI object to disappear in the first direction after displaying the upper limit line.

In an embodiment of the disclosure, the at least one processor may be configured to, when a user input is identified through the second UI object while the electronic device performs the sliding operation, maintain the display of the second UI object in the second display area after the sliding operation is completed.

In an embodiment of the disclosure, the at least one processor may be configured to change transparency of the first UI object according to a moving distance of the first UI object.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities. Some of the plurality of entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for operating an electronic device, the method comprising:
changing a size of a first display area in response to identifying a user input instructing the electronic device to perform a sliding operation; and
based on a size of a first user interface (UI) object included in the first display area, displaying the first UI object in a first display area and a second UI object corresponding to the first UI object in a second display area while the size of the first display area is changed,
wherein the first display area includes a size-variable area, and the second display area includes a size-fixed area.

2. The method of claim 1, wherein the changing of the size of the first display area includes extending the first display area in a first direction.

3. The method of claim 2, wherein, based on the size of the first UI object included in the first display area, the displaying of the first UI object in the first display area and the second UI object corresponding to the first UI object in the second display area while the size of the first display area is changed includes:
moving the first UI object from the first display area toward the first direction; and
displaying the second UI object corresponding to the first UI object in the second display area.

4. The method of claim 3, wherein the displaying of the second UI object corresponding to the first UI object in the second display area includes moving and displaying the second UI object in the first direction from an opposite end, in the first direction, of the electronic device.

5. The method of claim 4, further comprising:
when a value corresponding to a width of the first UI object is smaller than half of a value corresponding to a width of the first display area, displaying the first UI object in duplicate in the first display area.

6. The method of claim 3, wherein the first UI object is moved only in a preset first section of an entire time required to perform the sliding operation.

7. The method of claim 6, wherein the moving of the first UI object includes:
moving the first UI object by a first value corresponding to a defined proportion of a height of an area including the first UI object and distinguished from the first UI objects and a height of the first UI object;
after moving the first UI object by the first value, displaying a line indicating a position of the first UI object at an end of the first UI object in the first direction; and
displaying the first UI object to disappear in the first direction after displaying the line.

8. The method of claim 3, further comprising:
in case that a user input is identified through the second UI object while the electronic device performs the sliding operation, maintaining the display of the second UI object in the second display area after the sliding operation is completed.

9. The method of claim 3, further comprising:
in case that no user input is identified through the second UI object while the electronic device performs the sliding operation, releasing the display of the second UI object in the second display area after the sliding operation is completed.

10. The method of claim 1, wherein the first UI object includes an address bar and an icon for performing a specific function.

11. The method of claim 1, wherein the second UI object includes an object having the same shape as the first UI object and capable of performing the same function.

12. The method of claim 11, further comprising:
changing transparency of the first UI object according to a moving distance of the first UI object.

13. An electronic device comprising:
memory storing one or more computer programs;
a rollable display including a second display area having a fixed size and a first display area drawn out from or drawn into the electronic device; and
one or more processors,
wherein the one or more computer programs include computer-executable instructions that, when executed by the one or more processors individually or collectively, cause the electronic device to:
in response to identifying a user input instructing the electronic device to perform a slide operation, change a size of the first display area, and
display a first user interface (UI) object in the second display area and the first display area while the size of the first display area is changed, based on a size of the first UI object included in the first display area, and
wherein a size of the second display area is not changed.

14. The electronic device of claim 13, wherein the one or more computer programs further include computer-executable instructions that, when executed by the one or more processors individually or collectively, cause the electronic device to extend the first display area in a first direction to change the size of the first display area.

15. The electronic device of claim 14, wherein the one or more computer programs further include computer-executable instructions that, when executed by the one or more processors individually or collectively, cause the electronic device to:
move and display the first UI object from the first display area toward the first direction, and
display a second UI object corresponding to the first UI object in the second display area.

16. The electronic device of claim 13, wherein the one or more computer programs further include computer-executable instructions that, when executed by the one or more processors individually or collectively, cause the electronic device to move and display the second UI object in the first direction from an opposite end, in the first direction, of the electronic device.

17. The electronic device of claim 16, further comprising:
when a value corresponding to a width of the first UI object is smaller than half of a value corresponding to a width of the first display area, displaying the first UI object in duplicate in the first display area.

18. The electronic device of claim 13, wherein the first UI object is moved only in a preset first section of an entire time required to perform the sliding operation.

19. One or more non-transitory computer-readable storage media storing computer-executable instructions that, when executed by a processor individually or collectively, cause an electronic device to perform operations, the operations comprising:
changing a size of a first display area in response to identifying a user input instructing the electronic device to perform a sliding operation; and
based on a size of a first user interface (UI) object included in the first display area, displaying the first UI object in a first display area and a second UI object corresponding to the first UI object in a second display area while the size of the first display area is changed,
wherein the first display area includes a size-variable area, and the second display area includes a size-fixed area.

20. The one or more non-transitory computer-readable storage media of claim 19, wherein the changing of the size of the first display area includes extending the first display area in a first direction.
